(19) United States
(12) Patent Application Publication
(10) Pub. No.: US 2025/0301514 A1
(43) Pub. Date: Sep. 25, 2025

(54) ELECTRONIC APPARATUS FOR BLUETOOTH SOURCE SWITCHING AND METHOD OF OPERATING THE SAME

(71) Applicant: SAMSUNG ELECTRONICS CO., LTD., Suwon-si (KR)

(72) Inventors: Sangmin BAE, Suwon-si (KR); JIn SEOL, Suwon-si (KR)

(73) Assignee: SAMSUNG ELECTRONICS CO., LTD., Suwon-si (KR)

(21) Appl. No.: 19/228,207

(22) Filed: Jun. 4, 2025

Related U.S. Application Data
(63) Continuation of application No. PCT/KR2025/003585, filed on Mar. 19, 2025.

(30) Foreign Application Priority Data
Mar. 19, 2024 (KR) 10-2024-0037913

(51) Int. Cl. H04W 76/10; G06F 3/0482

(52) U.S. Cl. CPC H04W 76/10; G06F 3/0482

(57) ABSTRACT

An electronic apparatus and an operating method is provided. The method includes connecting with a sink device based on a Bluetooth communication protocol; obtaining, from the sink device, a source device list, the source device list comprising information about one or more source devices that the sink device has connected with; selecting a target source device from among one or more source devices comprised in the source device list; and transmitting, to the sink device, information associated with the target source device, the information associated with the target source device indicating to the sink device that the sink device perform a connection operation with the target source device.

### CROSS-REFERENCES TO RELATED APPLICATIONS

This application is a bypass continuation of International Application No. PCT/KR2025/003585, filed on Mar. 19, 2025, with the Korean Intellectual Property Office, which claims priority from Korean Patent Application No. 10-2024-0037913, filed on Mar. 19, 2024, with the Korean Intellectual Property Office, the disclosures of which are incorporated herein in their entireties by reference.

### FIELD

Embodiments of the disclosure relate to an electronic apparatus and a method of operating the same, and more particularly, to an electronic apparatus facilitating source switching in Bluetooth communication and a method of operating the electronic apparatus.

### BACKGROUND

In order for a Bluetooth sink device to receive and output data from a Bluetooth source device, the Bluetooth sink device has to communicate with the Bluetooth source device through a pairing operation and a connection operation. In order for a Bluetooth sink device to connect with a Bluetooth source device to output data and then switch to another Bluetooth source device, the Bluetooth sink device has to perform a process of searching for and connecting with another new Bluetooth source device.

### SUMMARY

An embodiment of the disclosure provides an electronic apparatus facilitating Bluetooth source device switching and a method of operating the electronic apparatus.

According to an embodiment of the disclosure, an electronic apparatus may include a communication interface, memory storing one or more instructions, and at least one processor. The at least one processor may be configured to execute the one or more instructions that cause the at least one processor to connect with a sink device based on a Bluetooth communication protocol; obtain, from the sink device, a source device list, the source device list comprising information associated with one or more source devices that the sink device has connected with; select a target source device from among the one or more source devices comprised in the source device list; and transmit, to the sink device, information associated with the target source device, the information associated with the target source device indicating to the sink device that the sink device perform a connection operation with the target source device.

According to an embodiment of the disclosure, a method of operating an electronic apparatus may include connecting with a sink device based on a Bluetooth communication protocol; obtaining, from the sink device, a source device list, the source device list comprising information about one or more source devices that the sink device has connected with; selecting a target source device from among one or more source devices comprised in the source device list; and transmitting, to the sink device, information associated with the target source device, the information associated with the target source device indicating to the sink device that the sink device perform a connection operation with the target source device.

According to an embodiment of the disclosure, a non-transitory computer- readable recording medium may have recorded thereon at least one instruction that, when executed by at least one processor of an electronic apparatus, causes the at least one processor to: connect with a sink device based on a Bluetooth communication protocol; obtain, from the sink device, a source device list, the source device list comprising information associated with the one or more source devices that the sink device has connected with; select a target source device from among the one or more source devices comprised in the source device list; and transmit information about the target source device to the sink device, the information associated with the target source device indicating to the sink device that the sink device perform a connection operation with the target source device.

### BRIEF DESCRIPTION OF THE DRAWINGS

The above and other aspects, features, and advantages of an embodiment of the disclosure will become more apparent from a combination of the following detailed description and the accompanying drawings.

FIG. 1 is a diagram of a system for switching a connected source device according to a Bluetooth communication protocol, according to an embodiment of the disclosure.

FIG. 2 is a diagram of a system including an electronic apparatus, a sink device, and a target source device, according to an embodiment of the disclosure.

FIG. 3 is a block diagram of a sink device according to an embodiment of the disclosure.

FIG. 4 is a block diagram of an electronic apparatus according to an embodiment of the disclosure.

FIG. 5 is a flowchart of a process of operating a source device, according to an embodiment of the disclosure.

FIG. 6 is a flowchart of a process of operating a source device, according to an embodiment of the disclosure.

FIG. 7 is a flowchart of a pairing operation between devices, according to an embodiment of the disclosure.

FIG. 8 is a flowchart of a connection operation between paired devices, according to an embodiment of the disclosure.

FIG. 9 is an example of a source device list according to an embodiment of the disclosure.

FIG. 10 is an example of a source device list according to an embodiment of the disclosure.

FIG. 11 is a flowchart of a process of operating a source device, according to an embodiment of the disclosure.

FIG. 12 is an exemplary graphical user interface for allowing source device switching, according to an embodiment of the disclosure.

FIG. 13 is a diagram for illustrating an example of the operation illustrated in FIG. 11, according to an embodiment of the disclosure.

FIG. 14 is a flowchart of a process of operating a source device, according to an embodiment of the disclosure.

FIG. 15 is a diagram for illustrating an exemplary implementation of the operation illustrated in FIG. 14, according to an embodiment of the disclosure.

FIG. 16 is a flowchart of a process of operating a source device, according to an embodiment of the disclosure.

FIG. 17 is a flowchart of a process of operating a source device, according to an embodiment of the disclosure.

FIG. 18 is a diagram for illustrating a user interface for macro setting in a source device, according to an embodiment of the disclosure.

FIG. 19 illustrates an example of macro setting of a source device to be automatically connected to a sink device, according to an embodiment of the disclosure.

FIG. 20 is a flowchart of a process of operating a source device, according to an embodiment of the disclosure.

### DETAILED DISCLOSURE

Terms used herein will be briefly described and then the disclosure will be described in detail with reference to the accompanying drawings.

The terms used herein are those general terms currently widely used in the art in consideration of functions in the disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the disclosure. Thus, the terms used herein should be understood not as simple names but based on the meanings of the terms and the overall description of the disclosure.

Throughout the disclosure, when something is referred to as “including” an element, one or more other elements may be further included unless otherwise specified. Also, as used herein, the terms such as “units” and “modules” may refer to units that perform at least one function or operation, and the units may be implemented as hardware or software or a combination of hardware and software.

Throughout the disclosure, the expression “at least one of a, b or c” indicates

only a, only b, only c, both a and b, both a and c, both b and c, all of a, b, and c, or variations thereof.

Hereinafter, embodiments of the disclosure will be described in detail with reference to the accompanying drawings so that those of ordinary skill in the art may easily implement the embodiment of the disclosure. However, the disclosure may be embodied in many different forms and should not be construed as being limited to the embodiment set forth herein. Also, portions irrelevant to the description of the disclosure will be omitted in the drawings for a clear description of the disclosure, and like reference numerals will denote like elements throughout the specification.

As used herein, the term “user” may refer to a person controlling the function or operation of a computing apparatus or an electronic apparatus by using a control device and may include a viewer, a manager, or an installer.

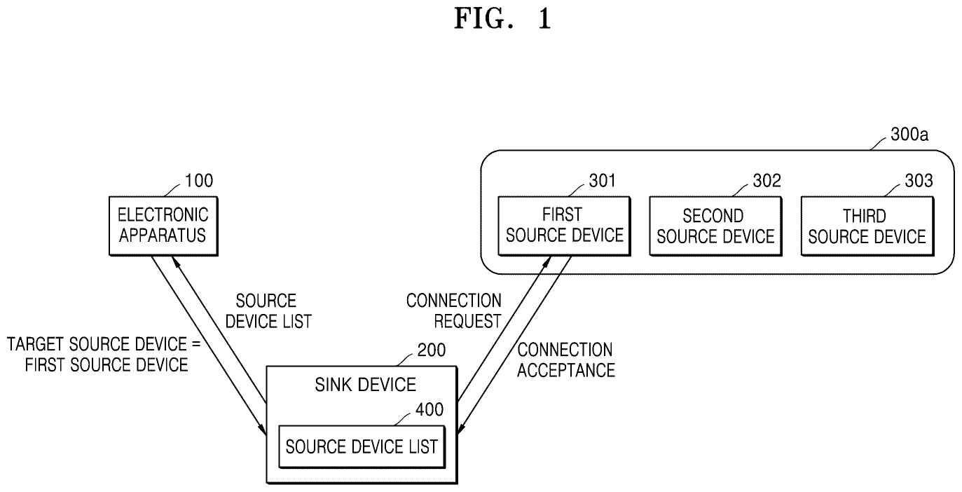

FIG. 1 is a reference diagram illustrating an example of a system for switching a connected source device according to a Bluetooth communication protocol, according to an embodiment of the disclosure.

Referring to FIG. 1, the system may include an electronic apparatus 100 connected with a sink device 200 according to the Bluetooth communication protocol, a sink device 200 connected with the electronic apparatus 100 according to the Bluetooth communication protocol, and source devices 300a including at least one source device that may be connected with the sink device 200 according to source device switching. The source devices 300a may include, for example, a first source device 301, a second source device 302, and a third source device 303.

The electronic apparatus 100 may be connected with the sink device 200 according to the Bluetooth communication protocol to provide data to the sink device 200.

The sink device 200 may be connected with the electronic apparatus 100 according to the Bluetooth communication protocol to receive data from the electronic apparatus 100.

In order for the electronic apparatus 100 and the sink device 200 to establish a connection according to the Bluetooth communication protocol to transmit/receive data, the electronic apparatus 100 and the sink device 200 may have to perform a pairing operation and a connection operation. Also, in order for the sink device 200 and another source device to establish a connection according to the Bluetooth communication protocol to transmit/receive data, the sink device 200 and the other source device may have to perform a pairing operation and a connection operation. For example, while the electronic apparatus 100 and the sink device 200 are connected and the sink device 200 receives and consumes data from the electronic apparatus 100, when the user wants to switch a source device to the first source device 301, the sink device 200 may have to disconnect from the electronic apparatus 100 and perform a pairing operation and a connection operation with the first source device 301. For example, it is assumed that the electronic apparatus 100 is a television (TV), the sink device 200 is a headset, and the first source device 301 is a smartphone. Then, when the user listens to audio data output from the TV in doors through Bluetooth communication with the headset and then wants to go out, the user may want to switch a source device providing audio data from the TV to the smartphone. In this case, even when the smartphone is a device having a history of being paired with the headset (that is, having been paired with the headset), the user may have to operate the smartphone again to connect with the headset in order to switch the source device from the TV to the smartphone. According to an embodiment of the disclosure, a method capable of more conveniently and easily switching a source device connected according to the Bluetooth communication protocol may be provided.

According to an embodiment of the disclosure, the sink device 200 may store a source device list 400 including information about one or more source devices to which the sink device 200 has been connected according to the Bluetooth communication protocol. This list may include source devices that the sink device has connected with in the past as well as the source devices that the sink device has connected with more recently. It may also include the source device(s) that the sink device is connected to. Whenever a connection is established with a source device, the sink device 200 may include and store information about the source device, which has been connected, in the source device list 400. For example, in FIG. 1, the source device list 400 may include information about the first source device 301, the second source device 302, and the third source device 303.

According to an embodiment of the disclosure, the sink device 200 may provide the source device list 400 to the electronic apparatus 100.

According to an embodiment of the disclosure, when a specified requirement is satisfied, the electronic apparatus 100 may select a target source device from among the source device list 400 received from the sink device 200 and transmit information about the selected target source device to the sink device 200. The sink device 200 may perform a connection operation with the target source device by using the information about the target source device.

According to an embodiment of the disclosure, when a specified event occurs, the electronic apparatus 100 may receive a user input for selecting a source device from among one or more source devices included in the source device list 400, determine, as a target source device, a source device selected according to the user input, and transmit information about the target source device to the sink device 200. The sink device 200 may perform a connection operation with the target source device by using the information about the target source device.

According to an embodiment of the disclosure, the electronic apparatus 100 may search for connectable source devices around (e.g., within a predetermined distance or a specified range) the electronic apparatus and display, based on a result of the searching, at least one connectable source device from among the at least one source device included in the source device list.

According to an embodiment of the disclosure, when a specified event occurs, the electronic apparatus 100 may automatically select a source device from among one or more source devices included in the source device list 400, determine the selected source device as a target source device, and transmit information about the target source device to the sink device 200.

According to an embodiment of the disclosure, the electronic apparatus 100 may select, as the target source device, a source device registered as a preferred device by the user from among the at least one source device included in the source device list.

According to an embodiment of the disclosure, the electronic apparatus 100 may select, as the target source device, a source device most recently connected to the sink device from among the at least one source device included in the source device list.

According to an embodiment of the disclosure, the electronic apparatus 100 may select, as the target source device, a source device most frequently connected to the sink device from among the at least one source device included in the source device list.

According to an embodiment of the disclosure, the electronic apparatus 100 may obtain mapping information including one or more pieces of position information and a source device corresponding thereto and select, as the target source device, a source device mapped to correspond to the position information from among the at least one source device included in the source device list, when the electronic apparatus is detected to be at a position corresponding to the position information.

According to an embodiment of the disclosure, the electronic apparatus 100 may provide or display a user interface for setting position information and a source device corresponding thereto and store the mapping information based on a user input received through the user interface.

According to an embodiment of the disclosure, when the sink device 200 receives information about the target source device from the electronic apparatus 100, the sink device 200 may terminate the connection with the electronic apparatus 100, transmit a connection request to the target source device according to the Bluetooth communication protocol, and receive a connection acceptance from the target source device, thereby establishing a connection according to the Bluetooth communication protocol. For example, when the sink device 200 receives information about the first source device 301 as a source device, the sink device 200 may transmit a connection request to the first source device 301 with reference to the information about the first source device 301.

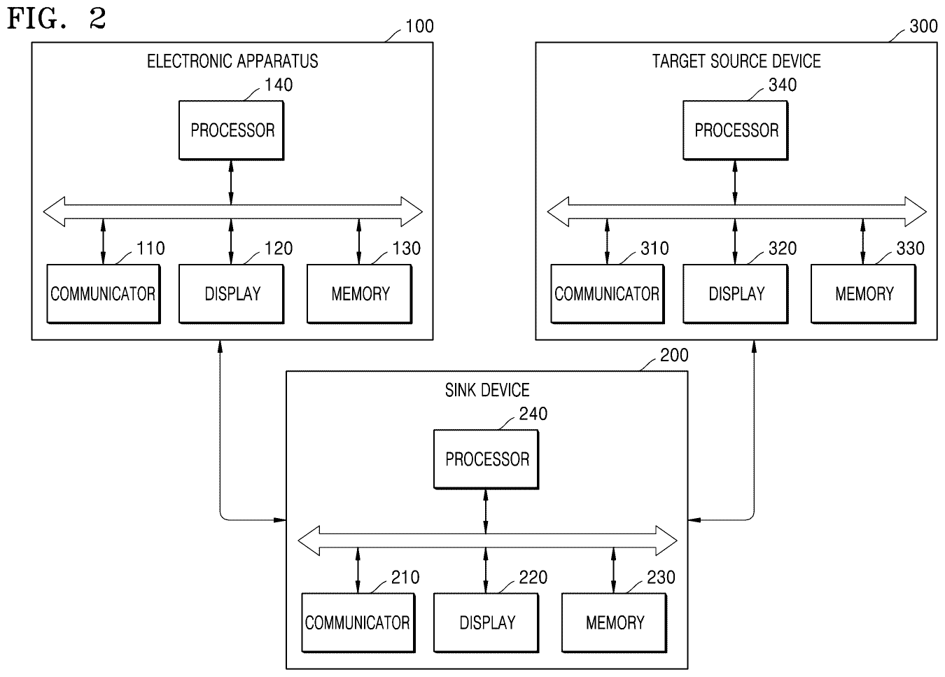

FIG. 2 illustrates an example of a system including an electronic apparatus 100, a sink device 200, and a target source device 300, according to an embodiment of the disclosure.

Referring to FIG. 2, the system may include an electronic apparatus 100, a sink device 200, and a target source device 300 connected through a communication network.

The electronic apparatus 100 may be an apparatus capable of displaying an image or data according to a user's request and may include a communicator (or communication interface) 110, a display 120, memory 130, and a processor 140.

The communicator 110 may include various communication circuitry for allowing communication with at least one external device. Here, ‘communication’ may refer to an operation of transmitting and/or receiving data, signals, requests, and/or commands.

The communicator 110 may perform wired or wireless communication with at least one external device. The external device may be the sink device 200, the target source device 300, or the like.

For example, the communicator 110 may include at least one of a communication module, communication circuitry, a communication device, an input/output port, or an input/output plug for performing wired or wireless communication with at least one external device.

For example, the communicator 110 may include at least one wireless communication module, wireless communication circuitry, or wireless communication device for performing wireless communication with at least one external device.

For example, the communicator 110 may include a short-range communication module such as an infrared (IR) communication module that may receive a control command from a remote controller located at a short distance. In this case, the communicator 110 may receive a control signal from the remote controller.

As another example, the communicator 110 may include at least one communication module performing communication according to the communication standard such as Bluetooth, WiFi, Bluetooth Low Energy (BLE), NFC/RFID, WiFi Direct, UWB, or ZigBee. Also, the communicator 110 may further include a communication module performing communication with a server for supporting long-range communication according to the long-range communication standard. For example, the communicator 110 may include a communication module performing communication through a network for Internet communication. Also, the communicator 110 may include a communication module performing communication through a communication network conforming to the communication standard such as 3G, 4G, 5G, and/or 6G.

As another example, the communicator 110 may include at least one port for connecting with an external device through a wired cable in order to communicate with the external device in a wired manner. For example, the communicator 110 may include at least one of a High-Definition Multimedia Interface (HDMI) port, a component jack, a personal computer (PC) port, or a Universal Serial Bus (USB) port. Accordingly, the communicator 110 may perform communication with the external device connected by wire through the at least one port. Here, the port may refer to a physical device component that may be used to connect or insert a cable, a communication line, a plug, or the like.

As described above, the communicator 110 may include at least one support element for supporting communication between the electronic apparatus 100 and the external device. Here, the at least one support element may include the communication module, the communication circuitry, the communication device, the port for data input/output, the cable port for data input/output, and/or the plug for data input/output described above. For example, the at least one support element included in the communicator 110 may include an Ethernet communication module, a WiFi communication module, a Bluetooth communication module, an IR communication module, a USB port, a tuner (or, broadcast receiver), an HDMI port, a display port (DP), and/or a digital visual interface (DVI) port.

The display 120 may output an image or data processed in the electronic apparatus 100.

The memory 130 may store one or more programs for processing and controlling by the processor 140 and may store data that is input to the electronic apparatus 100 or output from the electronic apparatus 100. Also, the memory 130 may store data for the operation of the electronic apparatus 100.

The memory 130 may include at least one type of storage medium from among flash memory type, hard disk type, multimedia card micro type, card type memory (e.g., SD and XD memories), random-access memory (RAM), static random-access memory (SRAM), read-only memory (ROM), electronically erasable programmable read-only memory (EEPROM), programmable read-only memory (PROM), magnetic memory, magnetic disk, and optical disk.

The processor 140 may control an overall operation of the electronic apparatus 100. For example, the processor 140 may perform the function of the electronic apparatus 100 described herein by executing one or more instructions stored in the memory 130.

The processor 140 may include various processing circuitry and/or a plurality of processors. For example, the term “processor” as used herein, including in the claims, may include various processing circuitry including at least one processor. In the at least one processor, one or more processors may be configured to individually and/or collectively perform various functions described herein in a distributed manner. As used herein, the “processor”, “at least one processor”, or “one or more processors” may be configured to perform various functions. However, these terms may cover, for example, but not limited to, a situation in which a processor may perform some of the functions and another processor or other processors may perform some others of the functions and a situation in which a single processor may perform all of the functions. Also, the at least one processor may include a combination of processors that perform various functions of the described functions in a distributed manner. The at least one processor may execute program instructions to achieve or perform various functions.

In an embodiment of the disclosure, the processor 140 may store one or more instructions in internal memory thereof and may execute the one or more instructions stored in the internal memory to perform control such that the operations of a display device are performed. That is, the processor 140 may perform a specified operation by executing at least one instruction or program stored in the internal memory of the processor 140 or in the memory 130.

According to an embodiment of the disclosure, the processor 140 may perform an operation of the electronic apparatus 100 described herein by executing one or more instructions stored in the memory 130.

According to an embodiment of the disclosure, the processor 140 may be configured to execute the one or more instructions stored in the memory 130 to connect with a sink device according to a Bluetooth communication protocol, obtain, from the sink device, a source device list including information about at least one source device to which the sink device has been connected, select a target source device from among the at least one source device included in the source device list, and transmit information about the selected target source device to the sink device such that the sink device performs a connection operation to the selected target source device.

According to an embodiment of the disclosure, the processor 140 may be configured to execute the one or more instructions stored in the memory 130 to display the at least one source device included in the source device list, based on a user input, receive an input for selecting a source device from the source device list, and determine, as the target source device, the source device selected according to the input.

According to an embodiment of the disclosure, the processor 140 may be configured to execute the one or more instructions stored in the memory 130 to search for connectable source devices around (e.g., within a predetermined distance or a specified range) the electronic apparatus and display, based on a result of the searching, at least one connectable source device from among the at least one source device included in the source device list.

According to an embodiment of the disclosure, the processor 140 may be configured to execute the one or more instructions stored in the memory 130 to detect occurrence of a specified event and select, according to the detecting, a target source device from among the at least one source device included in the source device list.

According to an embodiment of the disclosure, the processor 140 may be configured to execute the one or more instructions stored in the memory 130 to select, as the target source device, a source device registered as a preferred device by a user from among the at least one source device included in the source device list.

According to an embodiment of the disclosure, the processor 140 may be configured to execute the one or more instructions stored in the memory 130 to select, as the target source device, a source device most recently connected with the sink device from among the at least one source device included in the source device list.

According to an embodiment of the disclosure, the processor 140 may be configured to execute the one or more instructions stored in the memory 130 to select, as the target source device, a source device most frequently connected with the sink device from among the at least one source device included in the source device list.

According to an embodiment of the disclosure, the processor 140 may be configured to execute the one or more instructions stored in the memory 130 to obtain mapping information including one or more pieces of position information and a source device corresponding thereto and select, as the target source device, a source device mapped to correspond to the position information from among the at least one source device included in the source device list, when the electronic apparatus is detected to be at a position corresponding to the position information.

According to an embodiment of the disclosure, the processor 140 may be configured to execute the one or more instructions stored in the memory 130 to provide a user interface for setting position information and a source device corresponding thereto and store the mapping information based on a user input received through the user interface.

The electronic apparatus 100 may be any type of apparatus that includes a processor and memory to perform a function. The electronic apparatus 100 may be a fixed or portable apparatus. For example, the electronic apparatus 100 may refer to an apparatus that includes a display to display image content, video content, game content, graphic content, and the like. The electronic apparatus 100 may include, for example, various types of electronic apparatuses capable of receiving and outputting content, such as TVs such as network TVs, smart TVs, Internet TVs, Web TVs, and IPTVs, computers such as desktops, laptops, and tablets, and various smart devices such as smartphones, cellular phones, game players, music players, video players, medical equipment, and home appliances. The electronic apparatus 100 may be referred to as a source device in terms of providing content and may also be referred to as a content providing device, an electronic device, a computing device, or the like.

A block diagram of the electronic apparatus 100 illustrated in FIG. 2 may be a block diagram for an embodiment of the disclosure. Each component of the block diagram may be integrated, added, or omitted according to the specifications of the electronic apparatus 100 that are actually implemented. That is, it is understood that two or more components may be combined into one component, or one component may be divided into two or more components. Also, a function performed in each block is to describe an embodiment of the disclosure, and a particular operation or device thereof is not intended to limit the scope of the disclosure.

In FIG. 2, the electronic apparatus 100 is illustrated as including a display; however, the disclosure is not limited thereto. For example, the electronic apparatus 100 may be an apparatus that provides content to an external display device including a display. The content may include, but not limited to, images, videos, audios, texts, games, and applications. The electronic apparatus 100 may include a set-top box (STB), a Blue-ray disk player, a digital versatile disk (DVD) player, a game device, a digital camera, a camcorder, a streaming device, a home theater, or the like. In this case, the electronic apparatus 100 may be connected with an external display device through an input/output port such as an HDMI port to transmit video/audio signals to the external display device. Alternatively, the electronic apparatus 100 may be connected with an external display device through wired communication, short-range wireless communication such as wireless LAN (WLAN), WiFi, or Bluetooth, or long-range wireless communication.

The sink device 200 will now be described.

The sink device 200 may include a communicator 210, an output unit 220 (referred to as display 220 in FIG. 2), memory 230, and a processor 240. However, the sink device 200 is not limited thereto and may include more components than the illustrated components.

The communicator 210 may include various communication circuitry included in one or more modules for allowing wireless communication between the sink device 200 and a wireless communication system or between the sink device 200 and a network in which another device is located. According to an embodiment of the disclosure, the communicator 210 may perform communication with the electronic apparatus 100 or the target source device 300 according to short-range communication technology. The short-range communication technology may include, for example, Bluetooth communication, WiFi communication, and IR communication.

The output unit 220 may output data received from the electronic apparatus 100 or the target source device 300. For example, the output unit 220 may include an audio output unit that may output audio data received from the electronic apparatus 100 or the target source device 300.

The memory 230 may store one or more programs for processing and controlling by the processor 240 and may store data that is input to the sink device 200 or output from the sink device 200.

The memory 230 may include at least one type of storage medium from among flash memory type, hard disk type, multimedia card micro type, card type memory (e.g., SD and XD memories), random-access memory (RAM), static random-access memory (SRAM), read-only memory (ROM), electronically erasable programmable read-only memory (EEPROM), programmable read-only memory (PROM), magnetic memory, magnetic disk, and optical disk.

The processor 240 may control an overall operation of the sink device 200. For example, the processor 240 may perform the function of the sink device 200 described herein by executing one or more instructions stored in the memory 230.

The processor 240 may include various processing circuitry and/or a plurality of processors. For example, the term “processor” as used herein, including in the claims, may include various processing circuitry including at least one processor. In the at least one processor, one or more processors may be configured to individually and/or collectively perform various functions described herein in a distributed manner. As used herein, the “processor”, “at least one processor”, or “one or more processors” may be configured to perform various functions. However, these terms may cover, for example, but not limited to, a situation in which a processor may perform some of the functions and another processor or other processors may perform some others of the functions and a situation in which a single processor may perform all of the functions. Also, the at least one processor may include a combination of processors that perform various functions of the described functions in a distributed manner. The at least one processor may execute program instructions to achieve or perform various functions.

In an embodiment of the disclosure, the processor 240 may store one or more instructions in internal memory thereof and may execute the one or more instructions stored in the internal memory to perform control such that the above operations are performed. That is, the processor 240 may perform a specified operation by executing at least one instruction or program stored in the internal memory of the processor 240 or in the memory 230.

According to an embodiment of the disclosure, the processor 240 may execute the one or more instructions stored in the memory 230 to perform a communication connection with the electronic apparatus 100 by using short-range wireless communication technology. The short-range wireless communication technology may include Bluetooth communication technology, WiFi Direct technology, and the like.

According to an embodiment of the disclosure, the processor 240 may execute the one or more instructions stored in the memory 230 to control the communicator 210 to establish a communication connection with the electronic apparatus 100 according to the Bluetooth communication protocol.

According to an embodiment of the disclosure, the processor 240 may execute the one or more instructions stored in the memory 230 to store, in the memory 230, a source device list including information about at least one source device having been communicatively connected according to the Bluetooth communication protocol.

According to an embodiment of the disclosure, the processor 240 may execute the one or more instructions stored in the memory 230 to control the communicator 210 to transmit the source device list to the electronic apparatus 100.

According to an embodiment of the disclosure, the processor 240 may execute the one or more instructions stored in the memory 230 to control the communicator 210 to receive information about the target source device from the electronic apparatus 100.

According to an embodiment of the disclosure, the processor 240 may execute the one or more instructions stored in the memory 230 to control the communicator 210 to transmit a connection request to the target source device 300 with reference to the information about the target source device.

According to an embodiment of the disclosure, the processor 240 may execute the one or more instructions stored in the memory 230 to control the communicator 210 to receive a connection acceptance from the target source device 300.

The sink device 200 may be any type of device that includes a processor and memory to perform a function. The sink device 200 may include various electronic devices capable of performing Bluetooth communication. The sink device 200 may be referred to as a sink device in terms of receiving data from the electronic apparatus 100 and may also be variously referred to as an electronic device, a computing device, a content receiving device, a Bluetooth communication device, or the like.

Moreover, a block diagram of the sink device 200 illustrated in FIG. 2 may be a block diagram for an embodiment of the disclosure. Each component of the block diagram may be integrated, added, or omitted according to the specifications of the sink device 200 that are actually implemented. That is, is is understood that two or more components may be combined into one component, or one component may be divided into two or more components. Also, a function performed in each block is to describe an embodiment of the disclosure, and a particular operation or device thereof is not intended to limit the scope of the disclosure.

The target source device 300 will now be described.

The target source device 300 may include a communicator 310, a display 320, memory 330, and a processor 340. However, the target source device 300 is not limited thereto and may include more components than the illustrated components. For example, the target source device 300 may include a separate image processor for image processing of an application image executed in the target source device 300.

The communicator 310 may include various communication circuitry included in one or more modules for allowing wireless communication between the target source device 300 and a wireless communication system or between the target source device 300 and a network in which another device is located. According to an embodiment of the disclosure, the communicator 310 may perform communication with the sink device 200 according to the Bluetooth communication protocol.

The display 320 may display an image or data processed in the target source device 300.

The memory 330 may store one or more programs for processing and controlling by the processor 340 and may store data that is input to the target source device 300 or output from the target source device 300.

The memory 330 may include at least one type of storage medium from among flash memory type, hard disk type, multimedia card micro type, card type memory (e.g., SD and XD memories), random-access memory (RAM), static random-access memory (SRAM), read-only memory (ROM), electronically erasable programmable read-only memory (EEPROM), programmable read-only memory (PROM), magnetic memory, magnetic disk, and optical disk.

The processor 340 may control an overall operation of the target source device 300. For example, the processor 340 may perform the function of the target source device 300 described herein by executing one or more instructions stored in the memory 330.

The processor 340 may include various processing circuitry and/or a plurality of processors. For example, the term “processor” as used herein, including in the claims, may include various processing circuitry including at least one processor. In the at least one processor, one or more processors may be configured to individually and/or collectively perform various functions described herein in a distributed manner. As used herein, the “processor”, “at least one processor”, or “one or more processors” may be configured to perform various functions. However, these terms may cover, for example, but not limited to, a situation in which a processor may perform some of the functions and another processor or other processors may perform some others of the functions and a situation in which a single processor may perform all of the functions. Also, the at least one processor may include a combination of processors that perform various functions of the described functions in a distributed manner. The at least one processor may execute program instructions to achieve or perform various functions.

In an embodiment of the disclosure, the processor 340 may store one or more instructions in internal memory thereof and may execute the one or more instructions stored in the internal memory to perform control such that the above operations are performed. That is, the processor 340 may perform a specified operation by executing at least one instruction or program stored in the internal memory of the processor 340 or in the memory 330.

According to an embodiment of the disclosure, the processor 340 may execute the one or more instructions stored in the memory 330 to control the communicator 310 to receive a connection request from the sink device 200 according to the Bluetooth communication protocol.

According to an embodiment of the disclosure, the processor 340 may execute the one or more instructions stored in the memory 330 to control the communicator 310 to transmit a connection acceptance in response to the connection request from the sink device 200.

A block diagram of the target source device 300 illustrated in FIG. 2 may be a block diagram for an embodiment of the disclosure. Each component of the block diagram may be integrated, added, or omitted according to the specifications of the target source device 300 that are actually implemented. That is, it is understood that two or more components may be combined into one component, or one component may be divided into two or more components. Also, a function performed in each block is to describe an embodiment of the disclosure, and a particular operation or device thereof is not intended to limit the scope of the disclosure.

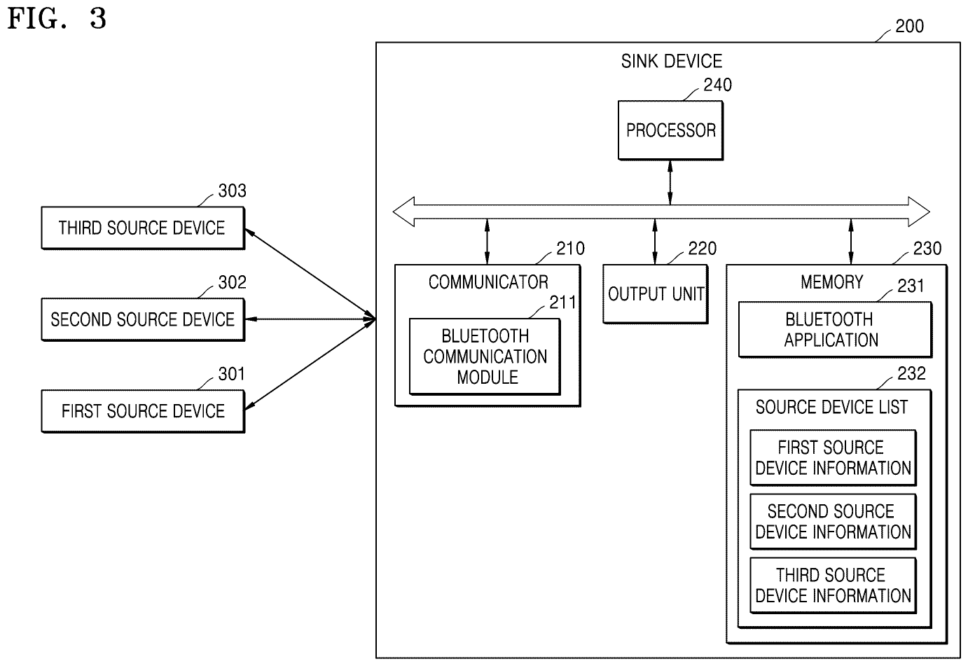

FIG. 3 illustrates an example of a block diagram of a sink device according to an embodiment of the disclosure.

Referring to FIG. 3, like in FIG. 2, the sink device 200 may include a communicator 210, an output unit 220, memory 230, and a processor 240.

The communicator 210 may include a Bluetooth communication module 211 for operation according to an embodiment of the disclosure.

The memory 230 may include a Bluetooth application 231 for allowing the sink device 200 to communicate according to the Bluetooth communication protocol.

The Bluetooth application 231 may include one or more instructions for allowing the sink device 200 to communicate according to the Bluetooth communication protocol and may also generate a source device list 232 by collecting information about one or more source devices to which the sink device 200 has been connected according to an embodiment of the disclosure.

The source device list 232 may include information about one or more source devices to which the sink device 200 has been connected. For example, when the sink device 200 has been connected with the first source device 301, the second source device 302, and the third source device 303, the source device list 232 may include first source device information, second source device information, and third source device information.

The processor 240 may update the source device list in order to store information about a connected source device whenever a connection occurs with a source device. The information about the source device may include identification information about the source device. The identification information about the source device may include at least one of BT MAC Address or BT Friendly Name. The information about the source device may further include connection time information representing information about the time when the sink device 200 has connected with the source device. The connection time information may include at least one of information about the time when the sink device 200 has started a connection with the source device, information about the time when the sink device 200 has terminated the connection with the source device, or information about the number of times the sink device 200 has connected with the source device during a certain period.

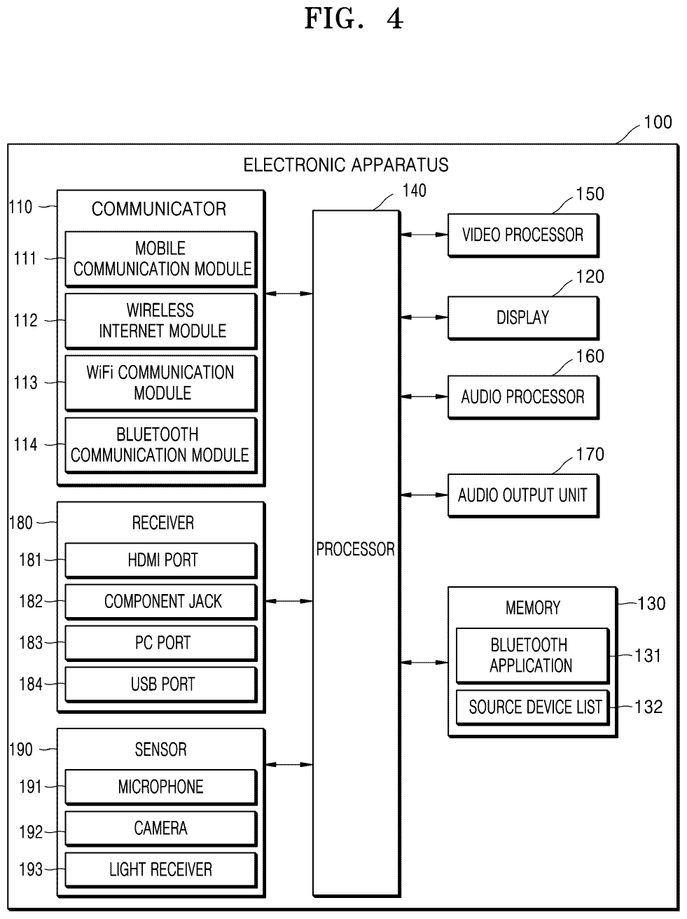

FIG. 4 illustrates an example of a block diagram of an electronic apparatus according to an embodiment of the disclosure.

Referring to FIG. 4, the electronic apparatus 100 may include a communicator 110, a display 120, memory 130, a processor 140, a video processor 150, an audio processor 160, an audio output unit 170, a receiver 180, and a sensor 190.

The communicator 110 may include various communication circuitry included in one or more modules for allowing wireless communication between the electronic apparatus 100 and a wireless communication system or between the electronic apparatus 100 and a network in which another electronic apparatus is located. For example, the communicator 110 may include a mobile communication module 111, a wireless Internet module 112, a WiFi communication module 113, and a Bluetooth communication module 114.

The mobile communication module 111 may transmit/receive wireless signals to/from at least one of a base station, an external terminal, or a server on a mobile communication network. The wireless signals may include voice call signals, video call signals, or various types of data according to transmission/reception of text/multimedia messages.

The wireless Internet module 112 may refer to a module for wireless Internet access and may be installed inside or outside a device. Wireless LAN (WLAN) (WiFi), Wireless broadband (WiBro), World Interoperability for Microwave Access (WiMAX), High Speed Downlink Packet Access (HSDPA), or the like may be used as wireless Internet technology. Through the wireless Internet module 112, the device may establish a WiFi peer-to-peer (P2P) connection with another device.

The communicator 110 may include a short-range communication module for short-range communication. Bluetooth, Bluetooth Low Energy (BLE), Radio Frequency Identification (RFID), Infrared Data association (IrDA), Ultra Wideband (UWB), ZigBee, or the like may be used as short-range communication technology. The communicator 110 may include a WiFi communication module 113 and a Bluetooth communication module 114 as a short-range communication module.

The WiFi communication module 113 may establish a communication connection and perform communication according to the WiFi communication protocol under the control by the processor 140.

The Bluetooth communication module 114 may establish a communication connection and perform communication with the sink device 200 according to the Bluetooth communication protocol under the control by the processor 140.

The Bluetooth communication module 114 may transmit data to the sink device 200 under the control by the processor 140.

The display 120 may display an image signal on a screen.

The memory 130 may store a program related to the operation of the electronic apparatus 100 and various data generated during the operation of the electronic apparatus 100.

The memory 130 may store at least one instruction. Also, the memory 130 may store at least one instruction executed by the processor 140. Also, the memory 130 may store at least one program executed by the processor 140. Also, the memory 130 may store an application for providing a specified service.

For example, the memory 130 may include at least one type of storage medium from among flash memory type, hard disk type, multimedia card micro type, card type memory (e.g., SD and XD memories), random-access memory (RAM), static random-access memory (SRAM), read-only memory (ROM), electronically erasable programmable read-only memory (EEPROM), programmable read-only memory (PROM), magnetic memory, magnetic disk, and optical disk.

According to an embodiment of the disclosure, the memory 130 may store a Bluetooth application 131 and a source device list 132 received from the sink device 200.

The processor 140 may control an overall operation of the electronic apparatus 100. For example, the processor 140 may perform the function of the electronic apparatus 100 described herein by executing one or more instructions stored in the memory 130.

In an embodiment of the disclosure, the processor 140 may store one or more instructions in internal memory thereof and may execute the one or more instructions stored in the internal memory to perform control such that the operations of a display device are performed. That is, the processor 140 may perform a specified operation by executing at least one instruction or program stored in the internal memory of the processor 140 or in the memory 130.

The processor 140 may include various processing circuitry and/or a plurality of processors. For example, the term “processor” as used herein, including in the claims, may include various processing circuitry including at least one processor. In the at least one processor, one or more processors may be configured to individually and/or collectively perform various functions described herein in a distributed manner. As used herein, the processor, at least one processor, or one or more processors may be configured to perform various functions. However, these terms may cover, for example, but not limited to, a situation in which a processor may perform some of the functions and another processor or other processors may perform some others of the functions and a situation in which a single processor may perform all of the functions. Also, the at least one processor may include a combination of processors that perform various functions of the described functions in a distributed manner. The at least one processor may execute program instructions to achieve or perform various functions.

According to an embodiment of the disclosure, the processor 140 may perform an operation of the electronic apparatus 100 described herein by executing one or more instructions stored in the memory 130.

Under the control by the processor 140, the video processor 150 may process an image signal received from the communicator 110 and output the resulting signal to the display 120.

Under the control by the processor 140, the audio processor 160 may convert an audio signal received from the receiver 180 or the communicator 110 into an analog audio signal and output the analog audio signal to the audio output unit 170.

The audio output unit 170 may output the audio (e.g., voice or sound) input through the communicator 110 or the receiver 180. Also, under the control by the processor 130, the audio output unit 170 may output the audio stored in the memory 130. The audio output unit 170 may include at least one of a speaker, a headphone output terminal, or a Sony/Philips Digital Interface (S/PDIF) output terminal, or any combination thereof.

The receiver 180 may receive, for example, a video (e.g., moving image), an audio (e.g., voice and music), and additional information (e.g., EPG) from outside the electronic apparatus 100 under the control by the processor 140. The receiver 180 may include one of an HDMI port 181, a component jack 182, a PC port 183, and a USB port 184, or any combination thereof. In addition to the HDMI port 181, the receiver 180 may further include a display port (DP), Thunderbolt, and Mobile High-Definition Link (MHL).

The sensor 190 may sense the user's voice, the user's image, or the user's interaction and may include a microphone 191, a camera 192, and a light receiver 193.

The microphone 191 may receive the user's utterance voice. The microphone 191 may convert the received voice into an electrical signal and output the electrical signal to the processor 140. The user's voice may include, for example, a voice corresponding to the function or menu of the electronic apparatus 100.

The camera 192 may receive an image (e.g., consecutive frames) corresponding to the user's motion including a gesture within a camera recognition range. By using the received motion recognition result, the processor 140 may select a menu displayed on the display apparatus 100 or may perform a control corresponding to the motion recognition result.

The light receiver 193 may receive a light signal (including a control signal) received from an external controller. The light receiver 193 may receive a light signal corresponding to a user input (e.g., touch, press, touch gesture, voice, or motion) from the external controller. The control signal may be extracted from the received light signal under the control by the processor 140.

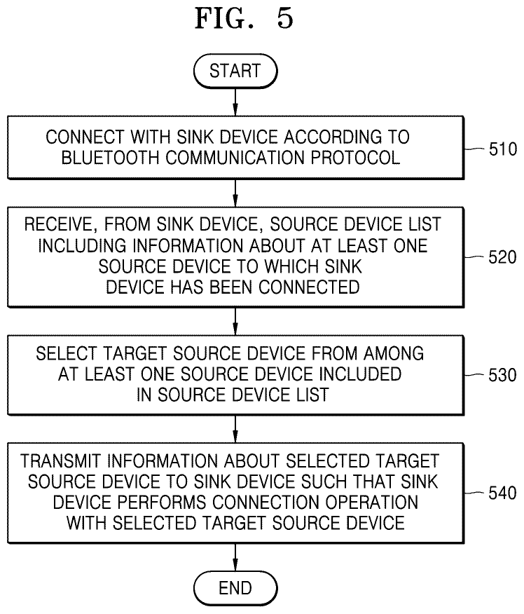

FIG. 5 illustrates an example of a flowchart of a method of operating a source device, according to an embodiment of the disclosure.

Referring to FIG. 5, in operation 510, the electronic apparatus 100 may connect with the sink device 200 according to the Bluetooth communication protocol.

In operation 520, the electronic apparatus 100 may receive, from the sink device 200, a source device list including information about at least one source device to which the sink device 200 has been connected. The source device list may include information about at least one source device to which the sink device 200 has been paired and connected. The information about the source device may include at least one of the BT MAC Address or the BT Friendly Name of the source device as identification information about the source device to which the sink device 200 has been connected.

In operation 530, the electronic apparatus 100 may select a target source device from among the at least one source device included in the source device list received from the sink device 200.

According to an embodiment of the disclosure, the electronic apparatus 100 may select a target source device based on a user input for selecting a source device from among the at least one source device. The electronic apparatus 100 may provide a graphical user interface for selecting a source device from among the at least one source device included in the source device list. When receiving a user input for selecting a source device through the graphical user interface, the electronic apparatus 100 may determine a selected source device as a target source device.

According to an embodiment of the disclosure, the electronic apparatus 100 may select, as a target source device, a source device having been most recently connected from among the at least one source device. For example, information about the at least one source device included in the source device list received from the sink device 200 may include information about the connection time. The electronic apparatus 100 may identify a source device having been most recently connected with reference to information about the time when each source device has been connected to a sink device.

According to an embodiment of the disclosure, the electronic apparatus 100 may select, as a target source device, a source device having been most frequently connected from among the at least one source device. For example, information about the at least one source device included in the source device list received from the sink device 200 may include information about the number of times of having been connected. The electronic apparatus 100 may identify a source device having been most frequently connected with reference to information about the number of times each source device has been connected to a sink device.

According to an embodiment of the disclosure, the electronic apparatus 100 may select, as a target source device, a source device preferred by the user from among the at least one source device. For example, the electronic apparatus 100 may store information about a source device registered as a user preferred device and may select a source device registered as a user preferred device from among the source devices as a target source device.

According to an embodiment of the disclosure, the electronic apparatus 100 may obtain mapping information including one or more pieces of position information and a source device corresponding thereto. When a source device is detected to be at a position corresponding to the position information included in the mapping information, the electronic apparatus 100 may select a source device mapped to correspond to the position information from among the at least one source device included in the source device list as a target source device. For example, the mapping information may include information that a home is mapped to a TV and an office is mapped to a smartphone. The electronic apparatus 100 may select a TV as a target source device when the electronic apparatus 100 detects that the electronic apparatus 100 is located at home. The electronic apparatus 100 may select a smartphone as a target source device when the electronic apparatus 100 detects that the electronic apparatus 100 is located at office.

In operation 540, the electronic apparatus 100 may transmit information about the selected target source device to the sink device 200 such that the sink device may perform a connection operation with the selected target source device. Then, the sink device 200 having received information about the target source device may transmit a connection request to the target source device with reference to the information according to the Bluetooth communication protocol and receive a connection acceptance in response to the connection request to perform a Bluetooth communication connection.

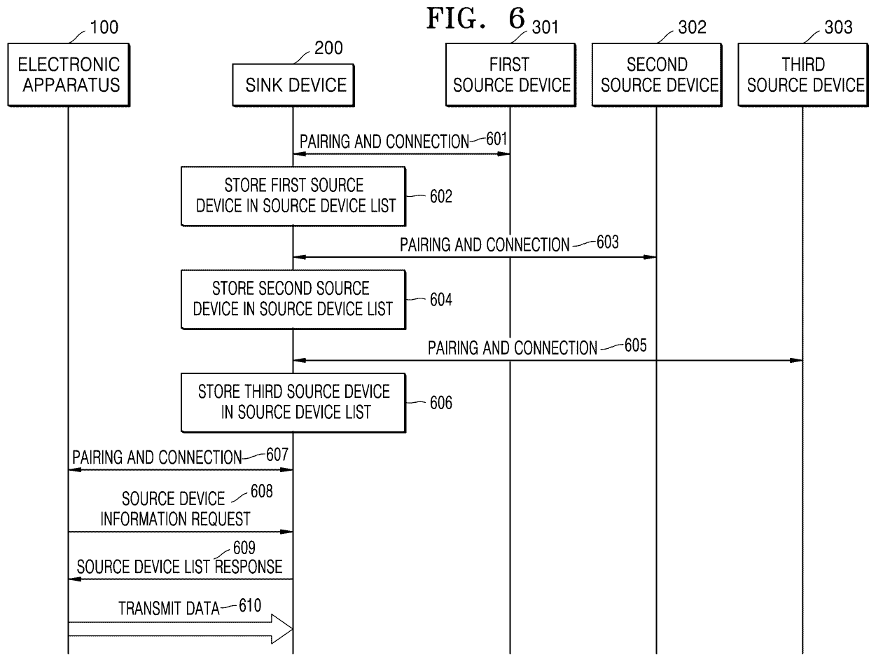

FIG. 6 illustrates an example of a flowchart of a method of operating a source device, according to an embodiment of the disclosure.

Referring to FIG. 6, in operation 601, the sink device 200 may perform a pairing and connection operation with the first source device 301 according to the Bluetooth communication protocol.

Pairing may be a process of authenticating each other and exchanging an encryption key with each other for secure communication between two Bluetooth devices. This process may be generally performed when the two devices first attempt to communicate with each other. Through the pairing process, the two devices may set a shared secret key that may be used to securely encrypt and exchange data during future communication. That is, the process may include authentication for allowing the two devices to identify each other's existence and pair with each other by the user, key exchange for exchanging an encryption key for secure communication between the two devices, and encryption setting for setting communication encryption based on the exchanged key.

The connection process may include setting a communication channel for actual data transmission between the two devices after the pairing is successfully completed. During the connection process, the two devices may recognize each other's existence and securely exchange data by using the encryption key that has already been shared. The connection may be a less complex process than the pairing and may generally be automatically performed without additional user intervention.

Bluetooth may be a standard that may be used for communication with various types of devices, and there may be profiles as separate protocols that may be used for the respective types of devices. Between the devices desiring to communicate with each other, communication may be performed by using the same profile. Representative Bluetooth profiles may include, for example, Advanced Audio Distribution Profile (A2DP) used to transmit voice to an audio device with a receiver, Hands-Free Profile (HFP) for hands-free calling, Headset Profile (HSP) for communication with a headset with built-in Bluetooth, Human Interface Device Profile (HID) for wireless connection with an input device such as a computer mouse or a keyboard, and Serial Port Profile (SPP) for serial communication between devices and all data transmission between devices.

A2DP may be used for the pairing and connection of operation 601.

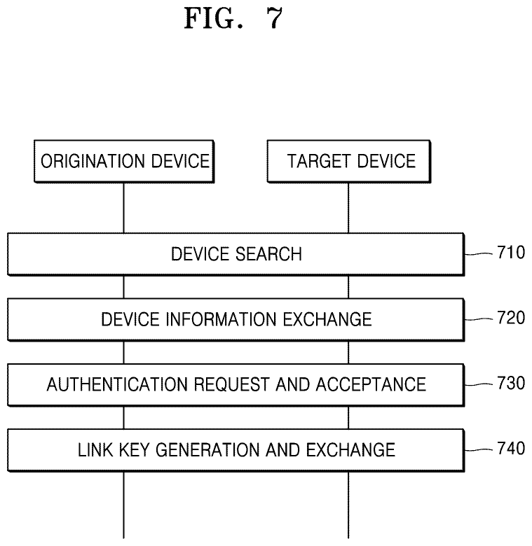

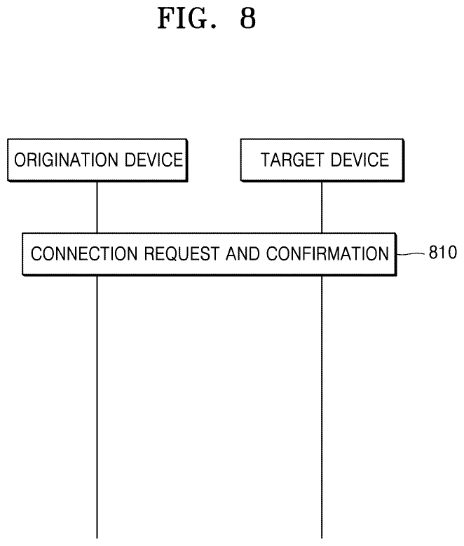

The paring and connection operation will be described in detail with reference to FIGS. 7 and 8.

FIG. 7 illustrates an example of a flowchart of a pairing operation between devices, according to an embodiment of the disclosure.

Referring to FIG. 7, a pairing operation between an origination device and a target device is described. The origination device may be, for example, a first source device and the target device may be a sink device. The origination device and the target device may operate according to an A2DP profile.

In operation 710, the devices may start a search and identification operation. Generally, in a device search and identification operation, when a device is set to a search mode and another device is set to a searchable mode, the device in the search mode may search for all Bluetooth devices around and the user may select a particular device to be paired with. When a device activates a Bluetooth search mode, the device may start to search for other Bluetooth devices around. Each device may broadcast its own BT MAC Address. The BT MAC Address may function as a unique identifier of the device and may be used to distinguish each device on the network. The device performing the search may receive the BT Friendly Name together with the BT MAC Address of a surrounding device when available. The BT Friendly Name may be a more friendly name for allowing the user to easily identify a device, and the user may identify and select a device to be connected through this name.

In operation 720, the paired devices may exchange device information with each other. In a device information exchange operation, the paired devices may exchange information such as the device type of each other, that is, the Bluetooth profile and function supported by the device. Through this information, the two devices may identify what kind of data they may exchange with each other.

In operation 730, the paired devices may perform an authentication request and acceptance. In an authentication request and acceptance operation, a device may request authentication from another device, and when the request is accepted, a secure connection may be made between the devices. This process may generally include an operation of inputting a PIN code or a key. For example, the authentication process of the two devices may be completed by inputting a PIN code set by the user or an automatically generated key. Thus, it may be confirmed that the communication between the two devices is secure.

In operation 740, the devices may perform link key generation and exchange. In a link key generation and exchange operation, the two devices may generate a unique link key and exchange the unique link key with each other. This key may be used to encrypt all communication between the two devices and may be continuously used while the pairing is maintained. As such, because the communication between the two devices is encrypted by using the link key, data may be securely transmitted to each other.

Through this process, a secure communication channel may be established between the Bluetooth devices. When the pairing is successfully completed, the devices may securely exchange data with each other through the encrypted link, and in subsequent communication, the link key may be reused to rapidly reestablish a secure connection.

FIG. 8 illustrates a flowchart of a connection operation between paired devices, according to an embodiment of the disclosure.

Referring to FIG. 8, in operation 810, the paired devices, that is, the origination device and the target device, may be automatically connected to each other through a connection and confirmation operation.

When the devices are reconnected after the pairing is completed, a process of exchanging the device names or the supported profiles with each other may be generally not as complex as the initial pairing setting. Because this information has already been exchanged and authentication has been completed in a pairing process, a reconnection process may be performed mainly by reconfirming a secure connection by using the previously shared link key. However, the devices may exchange some basic information to ensure the quality and compatibility of the connection. That is, by confirming each other's identity by using the link key generated and stored in the previous pairing process, the devices may ensure that the communication between the devices is secure. Also, in the reconnection process, the devices may exchange the device name or supported profile information again to reflect the changed setting or the updated software profile.

Referring back to FIG. 6, when the pairing and connection is made between the sink device 200 and the first source device 301 in operation 601, the sink device 200 may receive and process data from the first source device 301.

In operation 602, the sink device 200 may store information about the first source device 301 in the source device list. The sink device 200 may store information about the source device having been paired and connected with the sink device 200 in the source device list. The information about the source device stored in the source device list may include identification information about the source device having been connected. The identification information about the source device having been connected may include at least one of a BT MAC address used to identify a Bluetooth device or a BT Friendly Name used to easily identify a Bluetooth device by the user. For example, the sink device 200 may store at least one of the BT MAC address or the BT Friendly Name of the first source device 301 having been connected in the source device list.

In operation 603, when the pairing and connection is made between the sink device 200 and the second source device 302, the sink device 200 may receive and process data from the second source device 302.

In operation 604, the sink device 200 may store information about the second source device 302 in the source device list. For example, the sink device 200 may store at least one of the BT MAC address or the BT Friendly Name of the second source device 302 having been connected in the source device list.

In operation 605, when the pairing and connection is made between the sink device 200 and the third source device 303, the sink device 200 may receive and process data from the third source device 303.

In operation 606, the sink device 200 may store information about the third source device 303 in the source device list. For example, the sink device 200 may store at least one of the BT MAC address or the BT Friendly Name of the third source device 303 having been connected in the source device list.

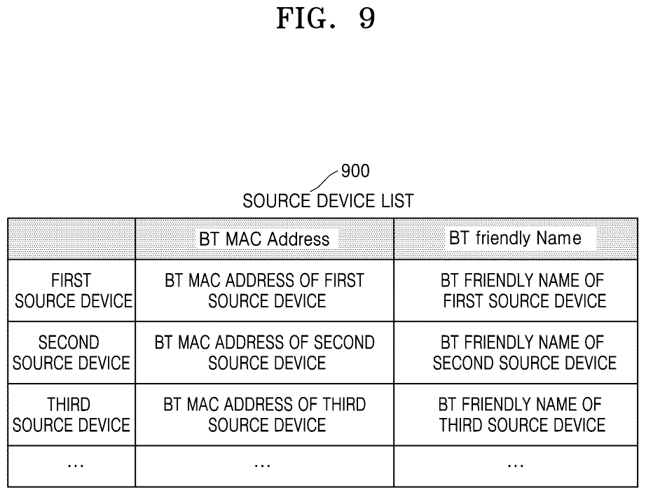

As such, the sink device 200 having been connected with the first source device 301 to the third source device 303 may store the source device list as illustrated in FIG. 9.

FIG. 9 illustrates an example of a source device list according to an embodiment of the disclosure.

Referring to FIG. 9, the source device list 900 may include the BT MAC address and BT Friendly Name of the first source device, the BT MAC address and BT Friendly Name of the second source device, and the BT MAC address and BT Friendly Name of the third source device. As such, whenever the sink device 200 is paired and connected with a new source device, the sink device 200 may store information about a connected source device in the source device list. Also, by providing the stored source device list to the connected source device, the sink device 200 may allow the source device to use the source device list when switching source devices.

In operation 607, pairing and connection may be performed between the sink device 200 and the electronic apparatus 100. As such, after the connection is performed between the sink device 200 and the electronic apparatus 100, the sink device 200 may store information about the source device as above; however, redundant descriptions thereof will be omitted for convenience of description.

In operation 608, the electronic apparatus 100 may transmit a source device information request to the sink device 200.

In operation 609, the sink device 200 may respond to the request by transmitting the source device list stored in the sink device 200 to the electronic apparatus 100 in response to the source device information request of the electronic apparatus 100.

In operation 610, the electronic apparatus 100 may transmit data to the sink device 200 according to the Bluetooth communication protocol.

As in the operation illustrated in FIG. 6, the sink device 200 according to an embodiment of the disclosure may store and manage information about the source device having been connected in the source device list whenever performing a connection operation with the source device. Also, the sink device 200 may provide the source device list to the source device whenever connected with the source device, such that the source device may use the information about the source device.

According to an embodiment of the disclosure, the sink device 200 storing the information about the source device in the source device list and the sink device 200 providing the source device list to the connected source device may occur not only when the sink device 200 is paired and connected to the source device but also when the sink device 200 is reconnected after having already been paired.

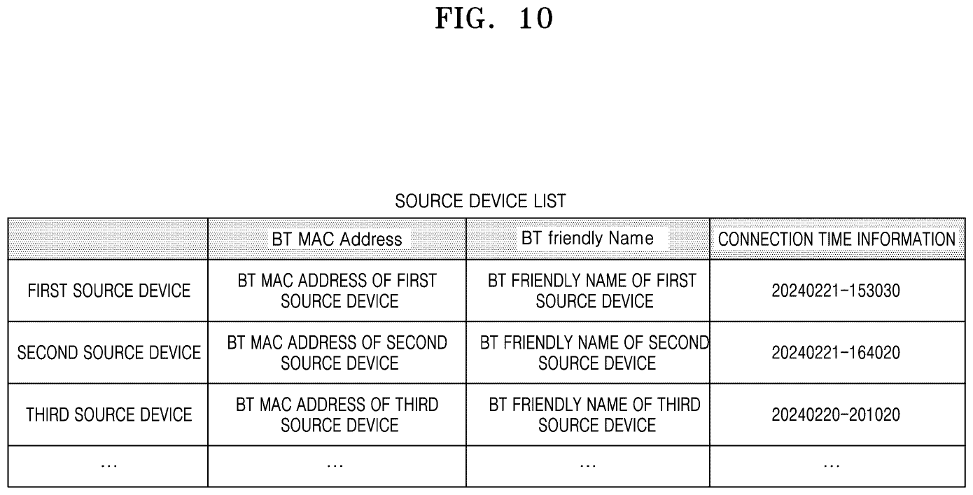

FIG. 10 illustrates an example of a source device list according to an embodiment of the disclosure.

While the source device list described in FIG. 9 includes the BT MAC Address and BT Friendly Name of the source device, information about the source device illustrated in FIG. 10 may further include connection time information in addition to the BT MAC Address and BT Friendly Name. The connection time information may include at least one of the time when the connection between the source device and the sink device has been started, the time when the connection between the source device and the sink device has been terminated, or the number of times the connection has been made during a specified period. With reference to the time when the connection has been started or the time when the connection has been terminated, the source device may determine which source device is a source device having been most recently connected. With reference to the information about the number of times the connection has been made, the source device may determine which source device is a source device having been most frequently connected.

For example, the connection time information may include the time when the connection between the source device and the sink device has been terminated. When the connection time information of the first source device represents 15:30:30 on February 21, 2024, the connection time information of the second source device represents 16:40:20 on Feb. 21, 2024, and the connection time information of the third source device represents 20:10:20 on Feb. 20, 2024, the electronic apparatus 100 may identify the second source device representing the most recent time as the source device having been most recently connected.

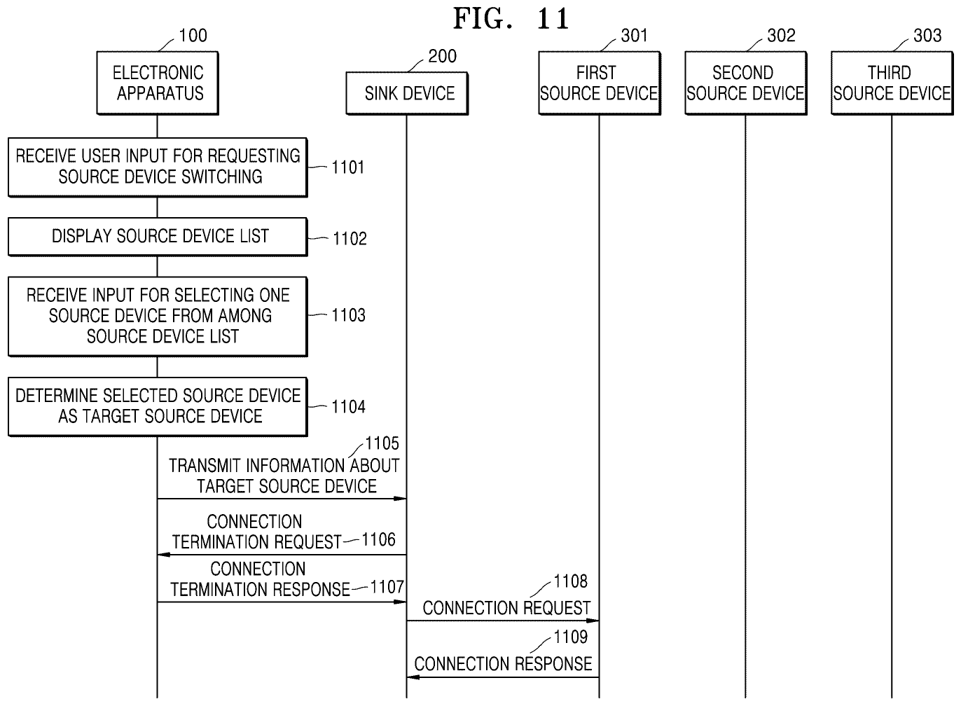

FIG. 11 illustrates an example of a flowchart of a method of operating a source device, according to an embodiment of the disclosure.

The operation illustrated in FIG. 11 may be performed after the electronic apparatus 100 and the sink device 200 are connected according to the operation illustrated in FIG. 6 and then the electronic apparatus 100 receives and stores the source device list from the sink device 200.

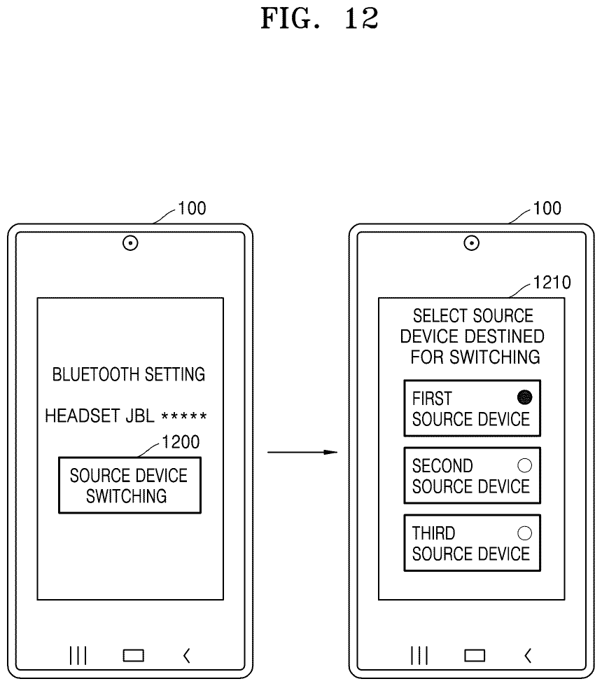

Referring to FIG. 11, in operation 1101, the electronic apparatus 100 may receive a user input for requesting source device switching. For example, the electronic apparatus 100 may provide a graphical user interface for allowing source device switching. According to this graphical user interface, a user input for requesting source device switching may be received from the user. For example, the electronic apparatus 100 may provide a graphical user interface as illustrated in FIG. 12.

FIG. 12 illustrates an example of a graphical user interface for allowing source device switching, according to an embodiment of the disclosure.

Referring to FIG. 12, the electronic apparatus 100 may include an item 1200 for allowing source device switching. When a user input for selecting the item 1200 is received, the electronic apparatus 100 may determine that a user input for requesting source device switching is received.

Referring back to FIG. 11, in operation 1102, the electronic apparatus 100 may display a source device list when a user input for requesting source device switching is received. The electronic apparatus 100 may display information about the source device included in the source device list received from the sink device 200 and stored therein.

For example, referring to FIG. 12, the electronic apparatus 100 may display information about the first source device, the second source device, and the third source device included in the source device list. The user may select one of the devices included in the displayed source device list.

In operation 1103, the electronic apparatus 100 may receive an input for selecting a source device from among the source device list.

In operation 1104, the electronic apparatus 100 may determine the selected source device as a target source device destined for source switching.

In operation 1105, the electronic apparatus 100 may transmit information about the target source device to the sink device 200. The information about the target source device may include at least one of the BT MAC Address or the BT Friendly Name about the target source device. For example, the electronic apparatus 100 may use the SPP protocol to transmit the information about the target source device to the sink device 200.

In operation 1106, the sink device 200 may transmit a connection termination request to the electronic apparatus 100 upon receiving the information about the target source device from the electronic apparatus 100.

In operation 1107, the electronic apparatus 100 may transmit a connection termination response to the sink device 200. Accordingly, the connection between the electronic apparatus 100 and the sink device 200 may be terminated.

In operation 1108, the sink device 200 may transmit a connection request to the target source device based on the information about the target source device received from the electronic apparatus 100. In operation 1109, the first source device 301 may transmit a connection response to the sink device 200. The sink device 200 and the first source device 301 may be automatically connected by the connection request and connection response. For example, when the target source device is the first source device, the sink device 200 may transmit a connection request to the first source device 301. Because the sink device 200 has been connected with the first source device, the sink device 200 may be automatically connected with the first source device 301 only by the connection operation illustrated in FIG. 8 without having to go through a pairing operation again.

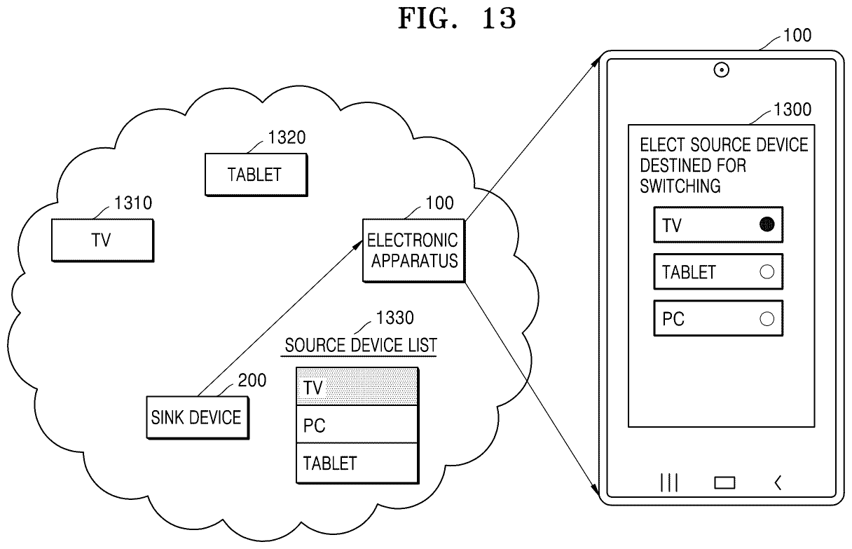

FIG. 13 is a reference diagram for describing an example of the operation illustrated in FIG. 11, according to an embodiment of the disclosure.

Referring to FIG. 13, when the electronic apparatus 100 and the sink device 200 are connected according to the Bluetooth communication protocol, the sink device 200 may provide a source device list 1330 to the electronic apparatus 100.

The electronic apparatus 100 and the sink device 200 may transmit/receive data according to the Bluetooth communication. Thereafter, when a source switching request is received in the electronic apparatus 100, the electronic apparatus 100 may provide a graphical user interface 1300 for selecting a source device destined for switching by outputting information about the source devices included in the source device list 1330 received from the sink device 200. For example, when the source device list 1330 includes a TV, a PC, and a tablet as source devices, the electronic apparatus 100 may include the TV, the PC, and the tablet in the graphical user interface 1300. When the user selects, for example, the TV among the source devices included in the displayed graphical user interface, the electronic apparatus 100 may transmit, to the sink device 200, information indicating that the selected target source device is the TV. Then, the sink device 200 may terminate the communication connection with the electronic apparatus 100, transmit a connection request to the TV 1310, and receive a connection response therefrom to establish a connection with the TV 1310.

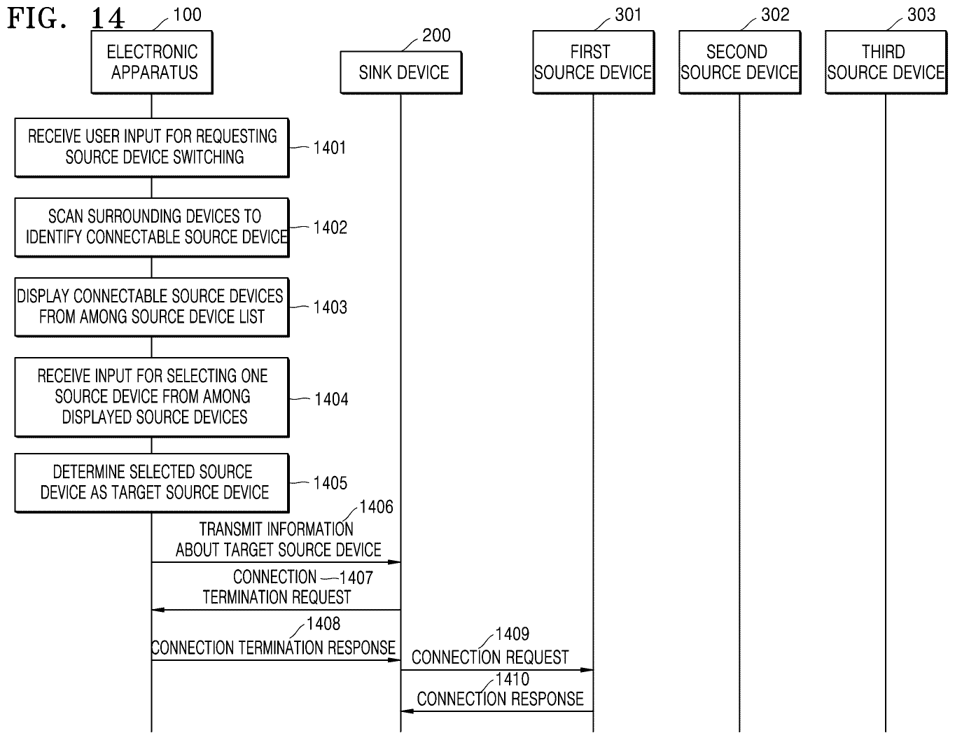

FIG. 14 illustrates an example of a flowchart of a method of operating a source device, according to an embodiment of the disclosure.

The operation illustrated in FIG. 14 may be performed after the electronic apparatus 100 and the sink device 200 are connected according to the operation illustrated in FIG. 6 and then the electronic apparatus 100 receives and stores the source device list from the sink device 200. The operation illustrated in FIG. 14 may be similar to the operation illustrated in FIG. 11, but operation 1102 illustrated in FIG. 11 may be replaced with operations 1402 and 1403 illustrated in FIG. 14. Among the operations illustrated in FIG. 14, operations corresponding to the operations illustrated in FIG. 11 will be briefly described.

Referring to FIG. 14, in operation 1401, the electronic apparatus 100 may receive a user input for requesting source device switching.

In operation 1402, the electronic apparatus 100 may scan surrounding devices to identify connectable source devices. The electronic apparatus 100 may display information about the source device destined for switching based on the source device list received from the sink device 200, but the information about the source device included in the source device list may also include information about a source device to which the sink device 200 is currently unconnectable. That is, because a source device list provided by the sink device 200 includes all information about the source devices to which the sink device 200 has been connected up to now, the source device list may include information about the source device currently within the connectable range of the sink device 200 and may also include information about the source device within the unconnectable range of the sink device 200. Because it is meaningless to provide information about the source device to which the sink device 200 is currently unconnectable, the electronic apparatus 100 may identify the source devices to which the sink device 200 is connectable and output only information about the source devices to which the sink device 200 is connectable from among the source device list as information about the switchable source devices. For this purpose, the electronic apparatus 100 may search for a Bluetooth device based on the Bluetooth communication protocol and identify the found source device as a connectable source device. For example, the electronic apparatus 100 may perform the device search process 710 illustrated in FIG. 7.

In operation 1403, the electronic apparatus 100 may display connectable source devices from among the source device list. That is, the electronic apparatus 100 may compare the source devices included in the source device list with the connectable source devices identified in operation 1402 by the electronic apparatus 100. Also, the electronic apparatus 100 may display the connectable source devices among the source devices included in the source device list as devices for source switching selection and may not display the unconnectable source devices among the source devices included in the source device list. As such, because the sink device 200 displays the currently connectable source devices as devices for source switching selection, the user may be prevented from uselessly selecting an unconnectable source device.

Because subsequent operations 1404 to 1410 correspond to operations 1103 to 1109 illustrated in FIG. 11, redundant descriptions thereof will be omitted for conciseness.

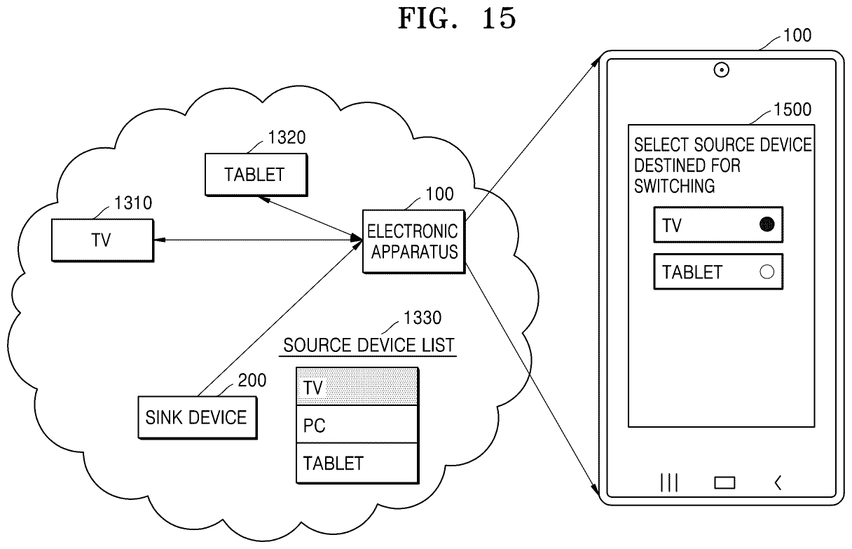

FIG. 15 is a reference diagram for describing an example of the operation illustrated in FIG. 14, according to an embodiment of the disclosure.

Referring to FIG. 15, when the electronic apparatus 100 and the sink device 200 are connected according to the Bluetooth communication protocol, the sink device 200 may provide a source device list 1330 to the electronic apparatus 100.

The electronic apparatus 100 and the sink device 200 may transmit/receive data according to the Bluetooth communication. Thereafter, when a source switching request is received in the electronic apparatus 100, the electronic apparatus 100 may provide a graphical user interface 1300 for selecting a source device destined for switching by outputting information about the source devices included in the source device list 1330 received from the sink device 200. For example, the source device list 1330 may include a TV, a PC, and a tablet as source devices. In this case, the electronic apparatus 100 may search for surrounding devices in advance and identify that there are a TV and a tablet as connectable devices. The electronic apparatus 100 may include the TV and the tablet in a graphical user interface 1500 as information about switchable source devices and may not include the PC therein because the PC is not a currently connectable device. When the user selects, for example, the TV among the source devices included in the displayed graphical user interface, the electronic apparatus 100 may transmit, to the sink device 200, information indicating that the selected target source device is the TV. Then, the sink device 200 may terminate the communication connection with the electronic apparatus 100, transmit a connection request to the TV 1310, and receive a connection response therefrom to establish a connection with the TV 1310. As such, the electronic apparatus 100 may not output information about the source devices included in the source device list received from the sink device 200 as switchable source device information but may output only information about devices connectable by the sink device 200, thereby preventing the user from uselessly selecting a source device that cannot connect with the sink device 200.

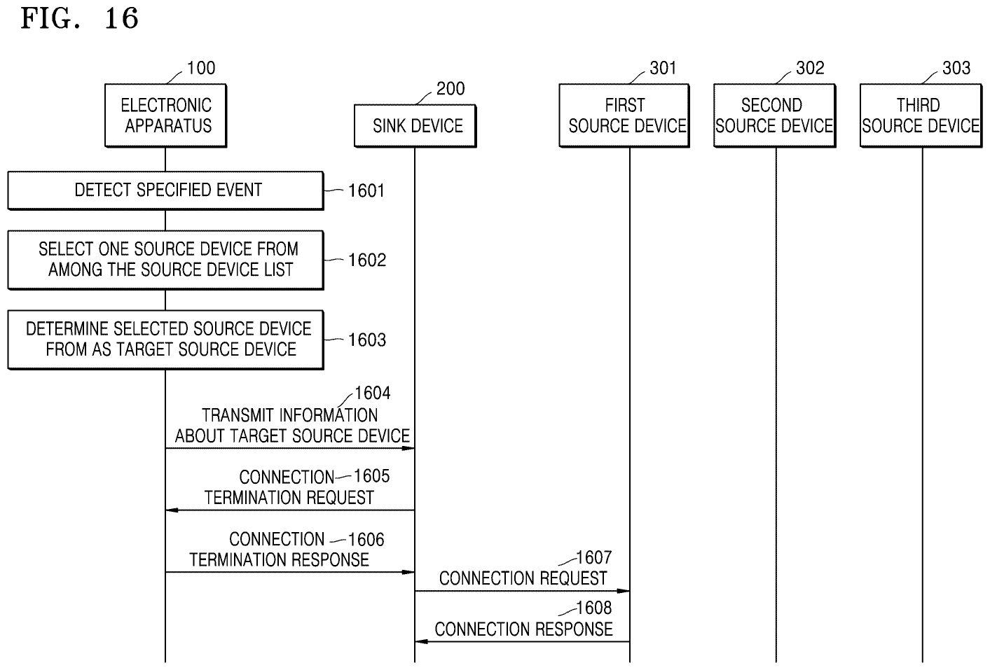

FIG. 16 illustrates an example of a flowchart of a method of operating a source device, according to an embodiment of the disclosure.

The operation illustrated in FIG. 16 may be performed after the electronic apparatus 100 and the sink device 200 are connected according to the operation illustrated in FIG. 6 and then the electronic apparatus 100 receives and stores the source device list from the sink device 200.

Referring to FIG. 16, in operation 1601, the electronic apparatus 100 may detect a specified event. The specified event may be variously determined but may be, for example, an event indicating a situation in which the electronic apparatus 100, which has been connected with the sink device 200 to transmit data to the sink device 200, has difficulty in transmitting data any longer. For example, the electronic apparatus 100 may be powered off, the electronic apparatus 100 may enter a standby mode, or an error may occur in the electronic apparatus 100, thus making it difficult to transmit data any longer.

In operation 1602, when the specified event is detected, the electronic apparatus 100 may select a source device from among the source device list. That is, when the electronic apparatus 100 has difficulty in transmitting data to the sink device 200 any longer due to a sudden reason, the electronic apparatus 100 may select a source device from among the source device list to switch to another source device capable of transmitting data.

According to an embodiment of the disclosure, the electronic apparatus 100 may select, from among the source device list, a source device preregistered as a preferred device. For example, the electronic apparatus 100 may receive an input of a preferred device preferred by the user and register the input preferred device as a preferred device. In this case, when there is a device registered as a preferred device by the user from among the source device list, the electronic apparatus 100 may select the preferred device as a device destined for source switching.

According to an embodiment of the disclosure, the electronic apparatus 100 may select, from among the source device list, a source device having been most recently connected. For example, as illustrated in FIG. 10, when the sink device 200 stores a source device having been connected in the source device list, the sink device 200 may further store information about the time of connection with the source device in addition to the BT MAC Address or BT Friendly Name of the source device. The connection time information may include at least one of information about the time when the sink device 200 has started to connect with the source device or information about the time when the connection with the source device has been terminated. As such, when receiving the source device list including information about the connection time, the electronic apparatus 100 may identify the most recently connected source device based on the information about the connection time. The electronic apparatus 100 may select the most recently connected source device from among the source device list.

According to an embodiment of the disclosure, the electronic apparatus 100 may select, from among the source device list, a source device having been most frequently connected. For example, as illustrated in FIG. 10, when the sink device 200 stores a source device having been connected in the source device list, the sink device 200 may further store information about the number of times of connection with the source device in addition to the BT MAC Address or BT Friendly Name of the source device. For example, the sink device 200 may store information about the number of times of connection with the source device in the source device list by using a counter to increase the count whenever connected with the source device during a certain period. As such, when receiving the source device list including information about the connection time, the electronic apparatus 100 may identify the most frequently connected source device based on the information about the connection time. The electronic apparatus 100 may select the most frequently connected source device from among the source device list by identifying the device with the highest number of times of connection as the most frequently connected source device.

In operation 1603, the electronic apparatus 100 may determine the selected source device as a target source device.

In operation 1604, the electronic apparatus 100 may transmit information about the target source device to the sink device 200. The information about the target source device may include at least one of the BT MAC Address or the BT Friendly Name about the target source device.

In operation 1605, the sink device 200 may transmit a connection termination request to the electronic apparatus 100 upon receiving the information about the target source device from the electronic apparatus 100.

In operation 1606, the electronic apparatus 100 may transmit a connection termination response to the sink device 200. Accordingly, the connection between the electronic apparatus 100 and the sink device 200 may be terminated.

In operation 1607, the sink device 200 may transmit a connection request to the target source device based on the information about the target source device received from the electronic apparatus 100. In operation 1608, the first source device 301 may transmit a connection response to the sink device 200. The sink device 200 and the first source device 301 may be automatically connected by the connection request and connection response. For example, when the target source device is the first source device, the sink device 200 may transmit a connection request to the first source device 301. Because the sink device 200 has been connected with the first source device, the sink device 200 may be automatically connected with the first source device 301 only by the connection operation illustrated in FIG. 8 without having to go through a pairing operation again.

According to an embodiment of the disclosure, the user may use a macro to preset a source device that he or she wants to connect to the sink device 200 at a particular position, such that the source device preset corresponding to the particular position may be automatically connected to the sink device 200 when the user is located at the particular position.

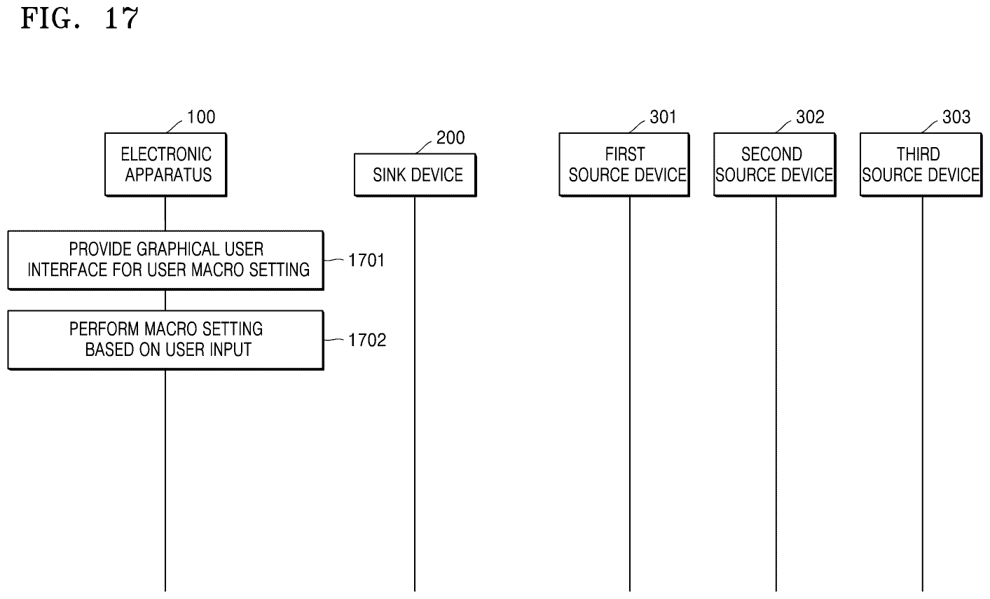

FIG. 17 illustrates an example of a flowchart of a method of operating a source device, according to an embodiment of the disclosure.

The operation illustrated in FIG. 17 may be performed after the electronic apparatus 100 and the sink device 200 are connected according to the operation illustrated in FIG. 6 and then the electronic apparatus 100 receives and stores the source device list from the sink device 200.

Referring to FIG. 17, in operation 1701, the electronic apparatus 100 may provide a graphical user interface for user macro setting.

In operation 1702, the electronic apparatus 100 may receive a user input based on the graphical user interface and register macro setting based on the user input.

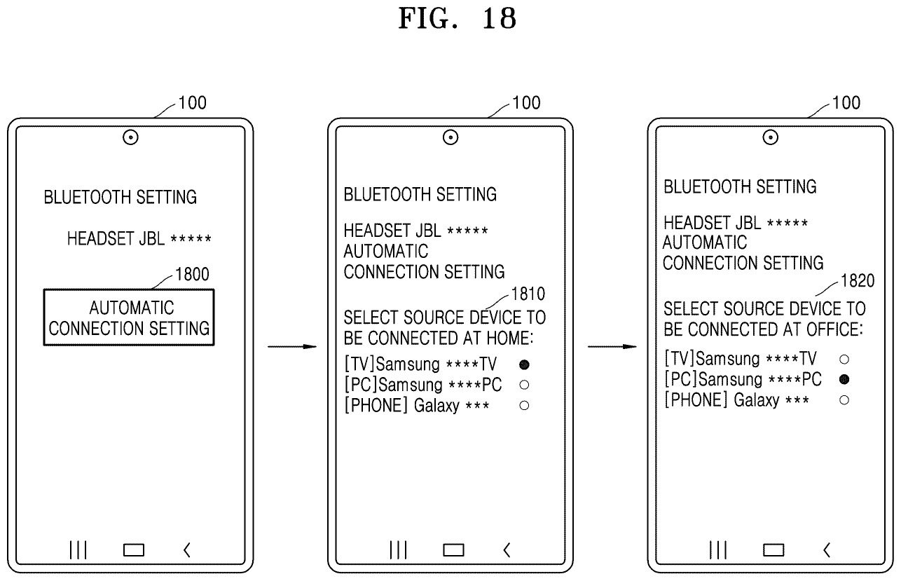

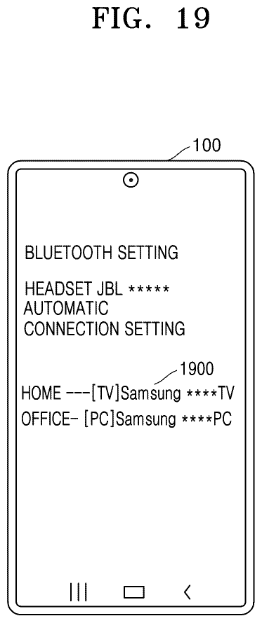

A method of registering the macro setting will be described in detail with reference to FIGS. 18 and 19.

FIG. 18 is a reference diagram for describing a user interface for macro setting in a source device, according to an embodiment of the disclosure.

Referring to FIG. 18, the electronic apparatus 100 may provide a menu 1800 for allowing a source device to be automatically connected according to a position with respect to a headset that is an example of the sink device 200.

When receiving an input for selecting the menu 1800 from the user, the electronic apparatus 100 may output, for example, a first user interface 1810. The first user interface 1810 may output a source device list for selecting a source device to be connected at home. For example, the first user interface 1810 may output TV, PC, and Phone as a source device list to be connected at home. According to a user input for selecting the TV among the output source devices, the electronic apparatus 100 may set the TV as the source device to be connected at home.

A second user interface 1820 may output a source device list for selecting a source device to be connected at office. For example, the second user interface 1820 may output TV, PC, and Phone as a source device list to be connected at office. According to a user input for selecting the PC among the output source devices, the electronic apparatus 100 may set the PC as the source device to be connected at office.

FIG. 19 illustrates an example of macro setting of a source device to be automatically connected to a sink device, according to an embodiment of the disclosure.

Referring to FIG. 19, a macro setting screen 1900 generated for automatic connection setting with respect to a headset according to the same user input as in FIG. 18 is illustrated. The macro setting screen 1900 may represent a setting in which a headset as an example of the sink device is automatically connected to the TV when the electronic apparatus 100 is detected to be located at home, and the headset is automatically connected to the PC when the electronic apparatus 100 is detected to be located at office.

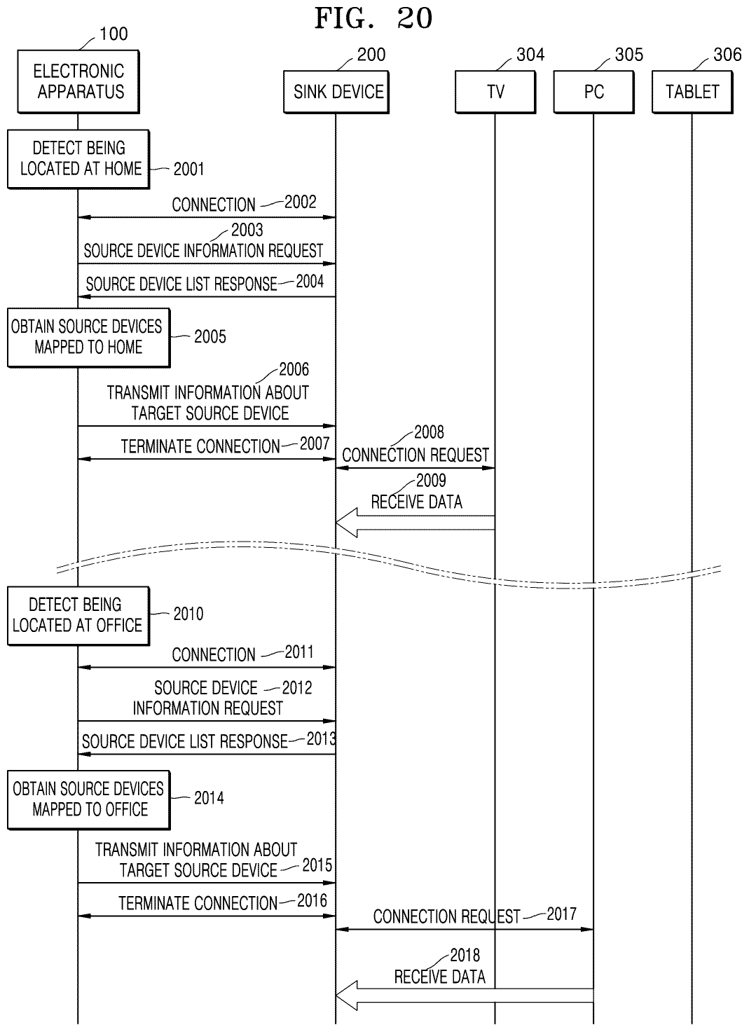

FIG. 20 illustrates an example of a flowchart of a method of operating a source device, according to an embodiment of the disclosure.

Referring to FIG. 20, in operation 2001, the electronic apparatus 100 may detect that the electronic apparatus 100 is located at home.

In operation 2002, the electronic apparatus 100 may perform a connection operation with the sink device 200 upon detecting that the electronic apparatus 100 is located at home.

In operation 2003, the electronic apparatus 100 may request source device information from the sink device 200 upon connection with the sink device 200.

In operation 2004, the electronic apparatus 100 may receive a response including the source device list from the sink device 200.

In operation 2005, the electronic apparatus 100 may obtain information about the source device mapped to the home according to automatic connection setting information. Referring to FIG. 19, for example, because a TV is mapped to the home, the electronic apparatus 100 may identify the TV as the source device mapped to the home.

In operation 2006, the electronic apparatus 100 may transmit information representing the TV as information about the target source device to the sink device 200.

In operation 2007, the sink device 200 may terminate the connection by transmitting a connection termination request to the electronic apparatus 100 and receiving a response thereto.

In operation 2008, the sink device 200 may connect with a TV 304 by transmitting a connection request to the TV 304 based on the information about the target source device and receiving a response thereto from the TV 304.

In operation 2009, the sink device 200 may receive data from the TV 304.

In operation 2010, the electronic apparatus 100 may detect that the electronic apparatus 100 is located at office.

In operation 2011, the electronic apparatus 100 may perform a connection operation with the sink device 200 upon detecting that the electronic apparatus 100 is located at office.

In operation 2012, the electronic apparatus 100 may request source device information from the sink device 200 upon connection with the sink device 200.

In operation 2013, the electronic apparatus 100 may receive a response including the source device list from the sink device 200.

In operation 2014, the electronic apparatus 100 may obtain information about the source device mapped to the office according to automatic connection setting information. Referring to FIG. 19, for example, because a PC 305 is mapped to the office, the electronic apparatus 100 may identify the PC 305 as the source device mapped to the office.

In operation 2015, the electronic apparatus 100 may transmit information representing the PC as information about the target source device to the sink device 200.

In operation 2016, the sink device 200 may terminate the connection by transmitting a connection termination request to the electronic apparatus 100 and receiving a response thereto.

In operation 2017, the sink device 200 may connect with the PC 305 by transmitting a connection request to the PC 305 based on the information about the target source device and receiving a response thereto from the TV PC.

In operation 2018, the sink device 200 may receive data from the PC 305.

According to an embodiment of the disclosure, a method of operating an electronic apparatus may include connecting with a sink device according to a Bluetooth communication protocol.

According to an embodiment of the disclosure, the method of operating the electronic apparatus may include obtaining, from the sink device, a source device list including information about at least one source device to which the sink device has been connected.

According to an embodiment of the disclosure, the method of operating the electronic apparatus may include selecting a target source device from among the at least one source device included in the source device list.

According to an embodiment of the disclosure, the method of operating the electronic apparatus may include transmitting information about the selected target source device to the sink device such that the sink device performs a connection operation to the selected target source device.

According to an embodiment of the disclosure, the method of operating the electronic apparatus may include displaying the at least one source device included in the source device list, based on a user input, receiving an input for selecting a source device from the source device list, and determining, as the target source device, the source device selected according to the input.

According to an embodiment of the disclosure, the method of operating the electronic apparatus may include searching for connectable source devices around (e.g., proximate to, within a predetermined distance, or within a specified range) the electronic apparatus, and displaying, based on a result of the searching, at least one connectable source device from among the at least one source device included in the source device list.

According to an embodiment of the disclosure, the method of operating the electronic apparatus may include detecting occurrence of a specified event, and selecting, according to the detecting, a target source device from among the at least one source device included in the source device list.

According to an embodiment of the disclosure, the method of operating the electronic apparatus may include selecting, as the target source device, a source device registered as a preferred device by a user from among the at least one source device included in the source device list.

According to an embodiment of the disclosure, the method of operating the electronic apparatus may include selecting, as the target source device, a source device most recently connected with the sink device from among the at least one source device included in the source device list.

According to an embodiment of the disclosure, the method of operating the electronic apparatus may include selecting, as the target source device, a source device most frequently connected with the sink device from among the at least one source device included in the source device list.

According to an embodiment of the disclosure, the method of operating the electronic apparatus may include obtaining mapping information including one or more pieces of position information and a source device corresponding thereto, and selecting, as the target source device, a source device mapped to correspond to the position information from among the at least one source device included in the source device list, when the electronic apparatus is detected to be at a position corresponding to the position information.

According to an embodiment of the disclosure, the method of operating the electronic apparatus may include providing a user interface for setting position information and a source device corresponding thereto, and storing the mapping information based on a user input received through the user interface.

According to an embodiment of the disclosure, a non-transitory computer-readable recording medium may have recorded thereon at least one instruction executed by a processor of an electronic apparatus to cause the electronic apparatus to connect with a sink device according to a Bluetooth communication protocol, obtain, from the sink device, a source device list including information about at least one source device to which the sink device has been connected, select a target source device from among the at least one source device included in the source device list, and transmit information about the selected target source device to the sink device such that the sink device performs a connection operation to the selected target source device.

An embodiment of the disclosure may also be implemented in the form of computer-readable recording mediums including instructions executable by computers, such as program modules executed by computers. The computer-readable recording mediums may be any available mediums accessible by computers and may include both volatile and non-volatile mediums and detachable and non-detachable mediums. Also, the computer-readable recording mediums may include computer storage mediums. The computer storage mediums may include both volatile and non-volatile and detachable and non-detachable mediums implemented by any method or technology for storage of information such as computer-readable instructions, data structures, program modules, or other data.

The described embodiment of the disclosure may be implemented as S/W programs including instructions stored in computer-readable storage mediums.

The computer may be an apparatus capable of calling instructions stored in a storage medium and performing an operation according to an embodiment of the disclosure according to the called instructions and may include the electronic apparatus according to an embodiment of the disclosure.

The computer-readable storage medium may be provided in the form of a non-transitory storage medium. Here, “non-transitory” may merely mean that the storage medium does not include signals and is tangible, but does not distinguish semi-permanent or temporary storage of data in the storage medium.

Also, the control method according to an embodiment of the disclosure may be included and provided in a computer program product. The computer program product may be traded as a product between a seller and a buyer.

The computer program product may include a S/W program and a computer-readable storage medium with a S/W program stored therein. For example, the computer program product may include products in the form of S/W programs (e.g., downloadable apps) electronically distributed through manufacturers of devices or electronic markets (e.g., Google Play Store and App Store). For electronic distribution, at least a portion of the S/W program may be stored in a storage medium or may be temporarily generated. In this case, the storage medium may be a storage medium of a server of a manufacturer, a server of an electronic market, or a relay server for temporarily storing the S/W program.

In a system including a server and a device, the computer program product may include a storage medium of the server or a storage medium of the device. Alternatively, when there is a third device (e.g., a smartphone) communicatively connected to the server or the device, the computer program product may include a storage medium of the third device. Alternatively, the computer program product may include the S/W program itself that is transmitted from the server to the device or the third device or transmitted from the third device to the device.

In this case, one of the server, the device, and the third device may execute the computer program product to perform the method according to an embodiment of the disclosure. Alternatively, two or more of the server, the device, and the third device may execute the computer program product to perform the method according to an embodiment of the disclosure in a distributed manner.

For example, the server (e.g., a cloud server or an artificial intelligence server) may execute the computer program product stored in the server, to control the device communicatively connected to the server to perform the method according to an embodiment of the disclosure.

As another example, the third device may execute the computer program product to control the device communicatively connected to the third device to perform the method according to an embodiment of the disclosure. When the third device executes the computer program product, the third device may download the computer program product from the server and execute the downloaded computer program product. Alternatively, the third device may perform the method according to an embodiment of the disclosure by executing the computer program product provided in a preloaded state.

Also, herein, the “unit” may include a hardware component such as a processor or circuitry and/or a software component executed by a hardware component such as a processor.

The foregoing descriptions of the disclosure are merely examples, and those of ordinary skill in the art will readily understand that various modifications may be made therein without materially departing from the spirit or features of the disclosure. Therefore, it is to be understood that the embodiment described above should be considered in a descriptive sense only and not for purposes of limitation. For example, each component described as a single type may also be implemented in a distributed manner, and likewise, components described as being distributed may also be implemented in a combined form.

The scope of the disclosure is defined not by the above detailed description but by the following claims, and all modifications derived from the meaning and scope of the claims and equivalent concepts thereof should be construed as being included in the scope of the disclosure.

What is claimed is:

1. An electronic apparatus comprising:
a communication interface;
memory storing one or more instructions; and
at least one processor,
wherein the at least one processor is configured to execute the one or more instructions that cause the electronic apparatus to:
connect with a sink device based on a Bluetooth communication protocol;
obtain, from the sink device, a source device list, the source device list comprising information associated with one or more source devices that the sink device has connected with;
select a target source device from among the one or more source devices comprised in the source device list; and
transmit, to the sink device, information associated with the target source device, the information associated with the target source device indicating to the sink device that the sink device perform a connection operation with the target source device.

2. The electronic apparatus of claim 1, wherein the at least one processor is configured to execute the one or more instructions that further cause the electronic apparatus to:
display, based on a user input, the one or more source devices comprised in the source device list;
receive an input indicative of selecting of the target source device from the source device list.

3. The electronic apparatus of claim 2, wherein the at least one processor is configured to execute the one or more instructions that further cause the electronic apparatus to:
search for connectable source devices within a predetermined distance of the electronic apparatus; and
display, based on a result of the searching, at least one connectable source device from among the one or more source devices comprised in the source device list.

4. The electronic apparatus of claim 1, wherein the at least one processor is configured to execute the one or more instructions that further cause the electronic apparatus to:
detect occurrence of a specified event; and
based on the detecting, select the target source device from among the one or more source devices comprised in the source device list.

5. The electronic apparatus of claim 4, wherein the at least one processor is configured to execute the one or more instructions that further cause the electronic apparatus to select, as the target source device, a source device registered as a preferred device by a user from among the one or more source devices comprised in the source device list.

6. The electronic apparatus of claim 4, wherein the at least one processor is configured to execute the one or more instructions that further cause the electronic apparatus to select, as the target source device, a source device most recently connected with the sink device from among the one or more source devices comprised in the source device list.

7. The electronic apparatus of claim 4, wherein the at least one processor is configured to execute the one or more instructions that further cause the electronic apparatus to select, as the target source device, a source device most frequently connected with the sink device from among the one or more source devices comprised in the source device list.

8. The electronic apparatus of claim 4, wherein the at least one processor is configured to execute the one or more instructions that further cause the electronic apparatus to:
obtain mapping information comprising the one or more source devices and one or more pieces of position information associated with respective source devices; and
based on the electronic apparatus being at a position comprised in the one or more pieces of position information, select, as the target source device, a source device associated with the position of the electronic apparatus.

9. The electronic apparatus of claim 8, wherein the at least one processor is configured to execute the one or more instructions that further cause the electronic apparatus to:
display a user interface for associating the one or more pieces of position information with the respective source devices; and
store the mapping information based on a user input received through the user interface.

10. A method of operating an electronic apparatus, the method being executed by one or more processors, and the method comprising:
connecting with a sink device based on a Bluetooth communication protocol;
obtaining, from the sink device, a source device list, the source device list comprising information about one or more source devices that the sink device has connected with;
selecting a target source device from among one or more source devices comprised in the source device list; and
transmitting, to the sink device, information associated with the target source device, the information associated with the target source device indicating to the sink device that the sink device perform a connection operation with the target source device.

11. The method of claim 10, further comprising:
displaying, based on a user input, the one or more source devices comprised in the source device list; and
receiving an input indicative of selecting the target source device from the source device list.

12. The method of claim 11, further comprising:
searching for connectable source devices within a predetermined distance of the electronic apparatus; and
displaying, based on a result of the searching, at least one connectable source device from among the one or more source devices comprised in the source device list.

13. The method of claim 10, further comprising:
detecting occurrence of a specified event; and
based on the detecting, selecting the target source device from among the one or more source devices comprised in the source device list.

14. The method of claim 13, further comprising selecting, as the target source device, a source device registered as a preferred device by a user from among the one or more source devices comprised in the source device list.

15. The method of claim 13, further comprising selecting, as the target source device, a source device most recently connected with the sink device from among the one or more source devices comprised in the source device list.

16. The method of claim 13, further comprising selecting, as the target source device, a source device most frequently connected with the sink device from among the one or more source devices comprised in the source device list.

17. The method of claim 13, further comprising:
obtaining mapping information comprising the one or more source devices and one or more pieces of position information associated with respective source devices; and
based on the electronic apparatus being at a position comprised in the one or more pieces of position information, selecting, as the target source device, a source device associated with the position of the electronic apparatus.

18. The method of claim 17, further comprising:
displaying a user interface associating the one or more position information with the respective source devices; and
storing the mapping information based on a user input received through the user interface.

19. A non-transitory computer-readable recording medium having recorded thereon at least one instruction that, when executed by at least one processor of an electronic apparatus, causes the electronic apparatus to:
connect with a sink device based on a Bluetooth communication protocol;
obtain, from the sink device, a source device list, the source device list comprising information associated with the one or more source devices that the sink device has connected with;
select a target source device from among the one or more source devices comprised in the source device list; and
transmit information about the target source device to the sink device, the information associated with the target source device indicating to the sink device that the sink device perform a connection operation with the target source device.
